(19) United States
(12) Patent Application Publication
(10) Pub. No.: US 2024/0415152 A1
(43) Pub. Date: Dec. 19, 2024

(54) METHODS FOR IMPROVING HEALTH OF FISH, USE OF ZINC OXIDE PARTICLES FOR THE PREPARATION OF FISH FEED, METHODS FOR PREPARING FISH FEED FOR FISH, AND FISH FEED THEREOF

(71) Applicant: City University of Hong Kong, Hong Kong (HK)

(72) Inventors: Wenxiong WANG, Hong Kong (HK); Shuoli MA, Hong Kong (HK)

(73) Assignee: City University of Hong Kong, Hong Kong (HK)

(21) Appl. No.: 18/329,944

(22) Filed: Jun. 6, 2023

(51) Int. Cl. A23K 20/20; A23K 50/80

(52) U.S. Cl. CPC A23K 20/20; A23K 50/80

(57) ABSTRACT

The present invention is concerned with a method of improving health of fish. The method has a step of feeding the fish with a fish feed, wherein the fish feed in its dried state has 60-93.35 mg/kg of zinc oxide (ZnO) particles.

### FIELD OF THE INVENTION

The present invention is concerned with a method for improving health of fish or particularly intestinal structures and intestinal health of the fish, a use of zinc oxide particles for the preparation of fish feed (fish formulation), a method for preparing fish feed (fish formulation) for fish, and a fish feed (fish formulation) thereof. The present invention is also concerned with a novel method of evaluating the internal structure of fish intestine.

### INCORPORATION BY REFERENCE

Sequence Listing file, in xml format, named H2690400, created on May 30, 2023, submitted on Jun. 6, 2023 via the USPTO patent electronic filing system, with a size of 6 KB, is incorporated herein by reference.

### BACKGROUND OF THE INVENTION

The following discussion of the background art is intended to facilitate an understanding of the present invention only. It should be appreciated that the discussion is not an acknowledgement or admission that any of the material referred to was part of the common general knowledge as at the priority date of the application.

The fishery industry is concerned with any activities in connection, for example, culturing and growing fish. There have been constant challenges in the industry of fish farming. These challenges include ensuring health of fish, promoting health of the fish, etc. Different fish feed additives have been proposed. These fish feed additives include, for example, zinc sulphate. However, while these feed additives are effective in some aspects, there remains a demand for alternatives for fish feed additives which can improve multiple aspects of the health of the fish.

The present invention seeks to address at least the aforementioned problems, or at least to provide alternatives to the public.

### SUMMARY OF THE INVENTION

According to a first aspect of the present invention, there is provided a method of improving health of fish, comprising a step of feeding the fish with a fish feed, wherein the fish feed in its dried state has 60-93.35 mg/kg of zinc oxide (ZnO) particles. The improving health of fish may be at least one of increasing body weight of fish, improving microbiota composition in the intestines of the fish, improving intestinal structures and intestinal health of the intestines of the fish, and regulating metabolism of glucose and lipid in the fish.

In an embodiment, the improving microbiota composition may be improving probiotics colonization of Lactic-acid bacilli spp. In a specific embodiment, the improving microbiota composition may be increasing presence of the combination of microorganisms from the phyla of Proteobactera, Firmicutes and Bacteroidota, or promoting colonization of the combination of microorganisms of Weissella, Lactococcus, Rhodobacteraceae, Globicatella, Lactobacillus, Streptococcus, Colwellia, Saprospiraceae, Anoxybacillus, Vibrio, and Synechococcus-CC9902.

In an embodiment, the improving structure of the intestines of the fish may be accelerating renewal of goblet cells in villus of the intestines, increasing height and/or area of the villus in the intestines, and/or increasing the number of goblet cells in the intestines.

Preferably, the ZnO particles may be zinc oxide nano-particles (nZnO).

Advantageously, the nZnO content in the fish feed may be 74.68-93.35 mg/kg of and thus the Zn content in the fish feed may be substantially 60-75 mg/kg. More preferably, the nZnO content in the fish feed may be substantially 74.68 mg/kg and thus the Zn content in the fish feed may be substantially 60 mg/kg.

Suitably, the nZnO may have an average diameter of 10-45 nm. More suitably, the nZnO may have an average diameter of 10-28 nm.

In an embodiment, the fish feed may be free of zinc sulphate (ZnSO4).

Preferably, the fish feed may contain protein selected from, for example, casein and soybean.

Suitably, the method may comprise feeding the fish with the fish feed twice a day, and maintaining the water temperature at 29-32° C., the oxygen level at 6.8-7.2 mg/L, and the salinity at 28-30%.

According to a second aspect of the present invention, there is provided a use of zinc oxide (ZnO) nano-particles (nZnO) for the preparation of a ZnO-containing fish feed for improving health of fish, wherein the fish feed in its dried state has a nZnO content of 60-93.35 mg/kg and a zinc content of substantially 48.25-75 mg/kg, and the nZnO particles have an average diameter of 10-45 nm.

Preferably, the improving health of fish may be at least one of increasing body weight of fish, improving microbiota composition in the intestines of the fish, improving structure of the intestines of the fish, and regulating the glucose and lipid metabolism of the fish.

According to the third aspect of the present invention, there is provided a method of preparing a fish feed for improving health of fish, comprising the steps of preparing a predetermined amount of fish feed, providing a predetermined amount of zinc oxide (ZnO) particles, adding the ZnO particles to an alcohol medium so that the ZnO particles is suspended in the alcohol medium and thus forming a ZnO-containing suspension additive, sonicating the ZnO-containing suspension additive, and adding the ZnO-containing suspension additive to the fish feed such that the fish feed, in its dried state, has a 60-93.35 mg/kg of the ZnO particles.

Preferably, the ZnO particles may be ZnO nano-particles (nZnO), and the fish feed in its dried state effectively has a 48.25-75 mg/kg of Zn, and the nZnO have an average diameter of 10-45 nm.

According to a fourth aspect of the present invention, there is provided a fish feed comprising 60-93.35 mg/kg of zinc oxide (ZnO) particles.

Preferably, the ZnO particles are ZnO nano-particles (nZnO) and have an average diameter of 10-45 nm.

According to a fifth aspect of the present invention, there is provided a method of evaluating the internal structure of fish intestine.

### BRIEF DESCRIPTION TO THE DRAWINGS

The patent or application file contains at least one drawing executed in color. Copies of this patent or patent application publication with color drawing(s) will be provided by the Office upon request and payment of the necessary fee.

Some embodiments of the present invention will now be explained, with reference to the accompanied drawings, in which:

FIG. 1 is a schematic diagram showing an overview of the present invention.

FIGS. 2a to 2h are graphs illustrating the serum biochemical indices and growth performance of golden pompano following dietary nZnO exposure for 5-week. [Key—HDL-C: high density lipoprotein cholesterol; LDL-C: low density lipoprotein cholesterol; GLU: glucose; AST/ALT: aspartate aminotransferase/alanine aminotransferase; TBIL: total bilirubin. WGR: weight gain rate, WGR (%)=100 (Wfinal weight−Winitial weight). ZnSO₄: ZnSO₄ group, Zn content: 60 mg/kg; nZnO(1): nZnO group, Zn content: 60 mg/kg; nZnO(2): nZnO group, Zn content: 170 mg/kg. Error bars represent the standard deviations of the 3 replicates (except for the initial weight and final weight, n=90). * as p<0.05, ** as p<0.01, and *** as p<0.001.]

FIGS. 3a, 3b, 3c, 3c1 to 3c5, 3d and 3e are graphs and diagram illustrating α-diversity and differential microorganisms at genus level using ASV-based methods of intestinal microorganism of golden pompano following dietary nZnO exposure for 5-week, in which, specifically, FIG. 3a shows index of community diversity, FIG. 3b shows PCoA on ASV level; FIGS. 3c & 3c1 to 3c5 show taxonomic composition of microbiota in the intestine at phylum level, FIG. 3d shows ZnSO₄ group vs nZnO(1), FIG. 3e shows nZnO(1) group vs nZnO(2). [Key—ZnSO₄: ZnSO₄ group, Zn content: 60 mg/kg; nZnO(1): nZnO group, Zn content: 60 mg/kg; nZnO(2): nZnO group, Zn content: 170 mg/kg. Error bars represent the standard deviations of 3 replicates. *p<0.05, **p<0.01, ***p<0.001.]

FIGS. 4a to 4d are charts and graphs showing differential microbial function prediction using PICRUSt2 and differential pathway analysis, in which, specifically, FIG. 4a illustrates ZnSO₄ vs. nZnO(1) 50 signaling pathways enriched in KEGG, FIG. 4b illustrates nZnO(1) vs nZnO(2) 50 signaling pathways enriched in KEGG, FIG. 4c illustrates 30 KEGG signaling pathways that differed significantly in ZnSO₄ vs nZnO(1), FIG. 4d illustrate 30 KEGG signaling pathways that differed significantly in nZnO(1) vs nZnO(2). [Key—ZnSO₄: ZnSO₄ group, Zn content: 60 mg/kg; nZnO(1): nZnO group, Zn content: 60 mg/kg; nZnO(2): nZnO group, Zn content: 170 mg/kg. Error bars represent the standard deviations of 3 replicates. p<0.05, **p<0.01, ***p<0.001.]

FIGS. 5a1 to 5a3 and 5b to 5j are images and graphs showing in situ spatial quantitative analysis of intestinal tissue of fish following 5-week dietary nZnO exposure, in which, specifically, FIGS. 5a1 to 5a3 are images of histomorphological section results in different groups (FIG. 5a1 illustrate localization of goblet cells), FIG. 5b is a graph illustrating the villus height distribution among three groups, FIG. 5c is a graph showing an analysis of the number of goblet cells in different locations among three groups, FIG. 5d is a graph illustrating the total number of goblet among three groups, FIG. 5e is a graph illustrating the villous region area among three groups, FIG. 5f is a graph showing the area of basal layer among three groups, FIG. 5g is a graph showing the villi length among three groups, FIG. 5h is a graph showing the villus/crypt ratio among three groups. [Key—ZnSO₄: ZnSO₄ group, Zn content: 60 mg/kg; nZnO(1): nZnO group, Zn content: 60 mg/kg; nZnO(2): nZnO group, Zn content: 170 mg/kg. Error bars represent the standard deviations of 3 replicates. (*p<0.05, **p<0.01, *** p<0.001).]

FIGS. 6a to 6e are graphs illustrating a correlation analysis, in which, FIG. 6a is a graph showing the heat map of intestinal structure index between ZnSO₄ and nZnO(1) group, FIG. 6b is a graph showing the heat map of intestinal microbial index between ZnSO₄ and nZnO(1) group, FIG. 6c is a graph showing the heat map of intestinal structure index between nZnO(1) and nZnO(2) group, FIG. 6d is a graph showing the heat map of intestinal microbial index between nZnO(1) and nZnO(2) group, FIG. 6e is a graph showing the mantel test of intestinal structure index and microbial index among three groups. [Key—a-d: correlation type: pearson test. e: mantel test. The positive correlation is shown in red and the negative correlation is shown in blue. The correlation coefficient is marked in the chart. The positive number is the correlation coefficient of positive correlation, and the complex number is the correlation coefficient of negative correlation. ZnSO₄: ZnSO₄ group, Zn content: 60 mg/kg; nZnO(1): nZnO group, Zn content: 60 mg/kg; nZnO(2): nZnO group, Zn content: 170 mg/kg.]

FIGS. 7a and 7b are an image and graphs illustrating particle characterization of ZnO NPs, in which, specifically, FIG. 7a is a representative TEM micrograph in absolute ethyl alcohol of the ZnO NP, and FIG. 7b is graph illustrating XRD spectrum pattern of the ZnO NPs.

FIGS. 8a to 8f are charts and graphs illustrating a quality analysis of microbial sequencing results, in which FIGS. 8a, 8c and 8e show the microorganisms at ASV level, and FIGS. 8b, 8d and 8f show the microorganisms at OTU level.

FIG. 9 is an image illustrating, schematically, morphological measurement indexes of intestinal villi, in which the straight-line distances from a to b, c to d and e to f were the villus height, crypt height and villus width, respectively.

FIGS. 10a1-1 to 10a1-3, FIG. 10a2-1 to FIG. 10a2-9, and FIG. 10a3-1 to FIG. 10a3-9 are images and graphs illustrating in situ spatial quantitative process of intestinal tissue of fish following 5-week dietary exposure, in which, specifically: FIG. 10a-1 to FIG. 10a1-3 show the histomorphological section results in different groups and the localization of goblet cells when the fish is treated with ZnSO₄, nZnO(2) and nZnO(2), respectively; FIGS. 10a2-1 to 10a2-3 correspond to FIG. 10a1-1, FIGS. 10a2-4 to 10a2-6 correspond to FIG. 10a1-2, and FIGS. 10a2-7 to 10a2-9 correspond to FIG. 10a1-3 and show the number of goblet cells in each section; and FIGS. 10a3-1 to 10a3-3 correspond to FIG. 10a1-1, FIGS. 10a3-4 to 10a3-6 correspond to FIG. 10a1-2 and FIGS. 10a3-7 to 10a3-9 correspond to FIG. 10a1-3 showing distribution of goblet cells in different basal layers in each section.

### DETAILED DESCRIPTION OF PREFERRED EMBODIMENTS OF THE INVENTION

While the use of zinc (Zn) has been known, the mechanisms of their uses as nutritional sources are less well understood. In the course leading the present invention, a regulatory mechanism of intestinal microbiota and structure mediated by zinc, and especially nano-Zn, has been identified. The improvement of the intestinal microbiota and structure thus leads to improvement of the health and growth of fish. Experiments were conducted in that fish diets were supplemented with 60 mg/kg ZnSO₄ (metal salt as the control group), 60 mg/kg nZnO (powder), or 170 mg/kg nZnO (powder) and then fed to the golden pompanos for 5 weeks. A new analytical amplicon sequence variant (ASV) method was employed to identify the bacterial species and achieved the first in situ spatial quantification of fish tissue samples. The results demonstrated that around 60 mg/kg of dietary nZnO unexpectedly promoted the probiotics colonization (Lactic-acid bacilli spp) in the intestine. At a higher nZnO (170 mg/kg) exposure, Brevinema and Mycoplasma colonized in the fish intestine as pro-inflammatory microorganisms, which activated the C5 isoprenoid biosynthesis pathway and NAD biosynthesis. Furthermore, dietary nZnO (60 mg/kg) up-regulated the expression of genes related to intestinal mucus secretion and accelerated the goblet cell renewal in the intestinal villi. At 170 mg/kg nZnO, fish intestine significantly down-regulated occludin and mucin gene expression while displayed lower villus height, villus area, and goblet cell numbers, which ultimately led to abnormal digestion and absorption and immune functions. Mantel test confirmed that intestinal microbial abundance was significantly correlated with the changes in the intestinal structure, while the value of villi/crypt ratio decreased with increasing Vibrio abundance, which were validated by the key genes and serum biochemical indexes. Finally, nZnO could regulate the glucose and lipid metabolism of fish by regulating microorganisms. The results illustrate the interaction between nZnO and fish intestinal microbial community and host. Further details of the present invention are depicted below.

In fish system, the intestine is a complex organ composed of intestinal epithelial cells. During the course leading the present invention, dietary Zn was believed first absorbed in the small intestine with the high-affinity Zn transporters [e.g., Zrt/Irt-like protein (ZIP) family in the epithelial cells, which were encoded by solute 30 family genes] 14. Zn absorption is also greatly affected by its intestinal availability from the diet, which depends on the lumen chemistry and the role of mucus secretion in the unstirred layer in absorbing Zn. The nanoparticles might be tangled in the mucus layer by the polyanionic matrix of mucin. With their large size, these nanoparticles may be taken up by endocytosis or phagocytosis process. The intestinal microbiome is an integral part of the epithelial surface and mucus layer, crucial for both nutrient metabolism and inherent immune function. Some evidence suggested the contribution of intestinal structure 17 or intestinal microbes 18 in assisting the fish intestine in responding to external environmental stress. However, very little is known on the mechanisms of ZnO or nZnO effects on the whole fish intestine health.

New technologies are essential to evaluate the physiological effects of nanoparticles on fish. Hematoxylin and eosin (HE) staining has been used in histopathological analysis, but is limited by manual tagging and small section size. Artificial intelligence (AI) technology advanced the analysis of diagnosis of ultra-large full-slice pathological images. By supplementing with analytical and statistical methods of tissue morphological structure recognition and flow-like analysis, the identified cells can be classified and counted by software self-learning based on the diameter, roundness, and color depth. Furthermore, each cell type's number presentation and statistics can be viewed in real-time mode when different thresholds are set to realize the backtracking verification of data and images. An embodiment of this method of the present invention allows big data statistical analysis of large images of complete intestinal cross-section tissue and distinguishes the spatial distribution and statistics of cells inside and outside the morphological structure of different tissue regions.

Quantitative analysis of microbial ecology (QIIME) is a bioinformatic tool for processing the microbiome data. Traditional operational taxonomic units (OTU) cluster analysis is based on 97% similarity, which is limited by the number of samples and has a higher comparison error rate. QIIME2 is a new classification standard (100% comparison method). Amplified sequence variation (ASV) clustering analysis was able to match more microorganisms, thus ASV denoising algorithm based on unbiased sequence selection has gradually replaced the OTU clustering method. Currently, both techniques are well established, but have not been extensively applied in assessing the biological impacts of nanomaterials.

In some embodiments of the present invention, intestinal microbiota diversity and intestinal structure mediated by nanoparticles and subsequently improved the health and growth of fish are revealed. Studies were carried out to assess the changes in fish (golden pompano Trachinotus ovatus) intestinal bacterial communities under different dietary nZnO exposures using traditional (QIIME1) and new clustering (QIIME2) methods. The morphological changes of fish intestinal histology using in situ quantitative spatial analysis are also evaluated, and the direct observation and quantitative measurements of the fish intestinal structure after nZnO exposure were observed. Meanwhile, serum biochemical indicators and growth performance were quantified to evaluate the effects of nZnO on fish. The finding may benefit the nZnO application on fish nutrition by improving intestinal health homeostasis.

### Materials and Methods

Characterization of nZnO

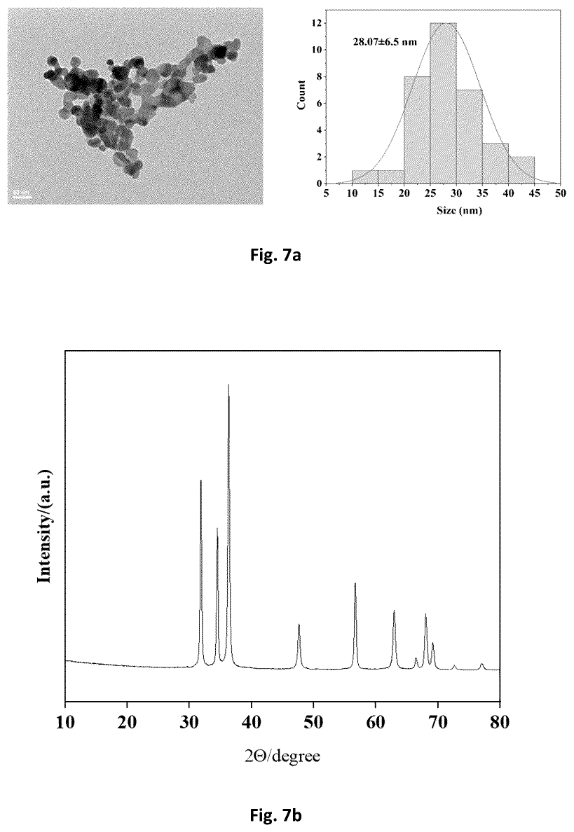

Zinc oxide (ZnO) nanoparticles (NPs) powders (Z112847, 30±10 nm, >99.99%) were purchased from Aladdin Reagent Inc (Shanghai, China). Zinc oxide NPs (5 mg) were suspended in 5 ml of 75% ethyl alcohol to prepare the 1 mg/mI suspension. The suspension was sonicated at room temperature for 45 min with a sonicator with three vortex mixes (15 min intervals). The sonicated nZnO suspension (dispersed nanoparticles) was dropped onto a carbon-coated copper grid, and its morphology and size were examined using transmission electron microscopy (TEM, Philips Technai 12) (FIG. 7). The crystal structure was determined by the X-ray diffractometer (XRD) (Panalytical) (FIG. 7). Dissolution of nZnO in an acid or alkaline environment was previously examined.

### Feed Formulation, Preparation, and Composition Analysis

The basal feed formula is shown in Table 1. Casein and soybean meal were chosen as the main protein sources to control the Zn contents in the background feeds. The process of feed preparation is shown as follows.

### The Process of Feed Preparation

Step 1—Raw ingredients sieve: This step aims to remove impurities from raw materials to ensure feed quality. All ingredients were sieved through the sieve (60 mesh), respectively.
Step 2—Ingredients mix: According to the feed formulation (Table 1), the weight of all ingredients was measured one by one. Then the ingredients were mixed using the blender mixer according to “the step by step” amplification principle. To blend all the ingredients, the different mixtures were made first. For example, using 1 kg feed
Mixture 1: 20 mg Choline chloride+20 mg Ca(H₂PO₃)₂+10 mg antioxidant+20 mg vitamin premix+20 mg mineral premix (Zn-free)+10 mg attractant.
Mixture 2: we mixed the 50 mg nZnO or ZnSO₄ with 30 mg α-Starch.
Mixture 3: mixed the 90 mg soybean lecithin, mixture 1 and mixture 2.
Mixture 4: mixed the mixture 3 (270 mg), fermented soybean meal (180 mg).
Mixture 5: mixed the 350 mg casein and 160 mg cassava starch.
Mixture 6: mix mixture 4 and mixture 5.
Step 3 Oil injection process: Put the soybean oil into the automatic oil injector. The mixed ingredients in Step 2 were sprayed with oil in proportion. After sparing, the mixes which we got was called premix compound.
Step 4-Pelleting: Different premix compounds were pelleted using a pellet-fodder expander through three processes: conditioning, curing and puffing. Finally, the expanded pellet diets were dried using the drying oven (50° C., 72 h).

There were a total of three experimental diets, including ZnSO₄ (ZnSO₄ supplementation at 50 mg/kg, metal salt control group), nZnO(1) (28 nm nZnO powder supplementation at 50 mg/kg), and nZnO(2) (28 nm nZnO powder supplementation at 150 mg/kg). All diets for fish feeding exposure were kept in the refrigerator (4° C.) before use. The moisture, crude protein, crude lipid, and ash contents in the diet were measured using standard methods 24. The feeds were first dried in an oven (105° C.) for 36 h to determine the moisture content. After acid digestion, the crude protein (N×6.25) content was determined by the Kjeldahl method. The crude lipid content of the dried feed was determined after extraction with petroleum ether. The dried feed was heated in the muffle furnace at 550° C. for 24 h to determine the ash content. The final dietary Zn levels in different groups were measured using ICP-MS (NexION 300X, PerkinElmer). The measured crude protein was 43.52% (dry matter), crude lipid was 11.6% (dry matter), ash was 5.87% (dry matter), and moisture was 8.40%, respectively. The final determined Zn contents were 60 (ZnSO₄, commercial diet as reference feed), 60 [nZnO(1)], and 170 [nZnO(2)] mg/kg in different diets (Table 1), which were slightly above the designated concentrations due to the inevitable trace Zn in the ingredients.

### Fish Exposure and Sampling

Fish exposure experiments were conducted in strict accordance with the Chinese Guidelines for Ethical Review of Laboratory Animal Welfare (GBIT 35892-2018). Three groups of golden pompanos (initial body wet weight of about 6 g) were randomly chosen and split after 14 days of acclimatization. There were three replicated net cages in Mirs Bay (Nanao, Shenzhen, China) for each group, with 30 fish in each duplicate. Each day, the experimental meals were given two-time (8:00 h, and 16:00 h) to golden pompano until satiation during the 5-week exposure experiment. The water was 29-32° C., dissolved oxygen 6.8-7.2 mg/L, and salinity 28-30‰ during dietary exposure.

After dietary exposure, all fish were starved for 24 h, and the ice-water was used to anesthetize fish from different groups. To avoid sample contamination during sampling, we first thoroughly disinfected the sampling table with 75% alcohol, and then spread a disposable tablecloth and disinfected it twice. All metal dissection tools were high-temperature sterilization. Each treatment group shared one set of dissection tools. After each set of samples, the disposable tablecloth was replaced and thoroughly sterilized for the following group sampling. The tubes (sterile and enzyme-free) for the temporary storage of samples were purchased from Corning. Inc. The alcohol lamp was kept on throughout the sampling process. Fish's weights were measured immediately. All individual fish per net were swabbed using 75% alcohol. After that, we used a 1 mL disposable syringe to collect the blood from the caudal vertebra of the fish. The blood was quickly drawn into the pre-cooled 1.5 mL-centrifuge tubes (RNA-free tube). Then, all the blood samples were put in the 4° C. refrigerator for 24 h, and then centrifuged (4° C., 3000 r/min, 10 min) to obtain the serum samples for biochemical analysis. The blood-drawn fish were quickly dissected to obtain the gill, intestine content, intestine, liver, and muscle. Each replicated sample contained 6 fish, resulting in 18 fish per treatment group (with 3 replicates). All these samples were immediately frozen in liquid nitrogen and transferred to −80° C. refrigerator using dry ice, except the intestine for histomorphological study. For histomorphological analysis of the intestine, the tissues (3 fish per treatment group) were firstly dissected in the medical ice sheet. After 0.9% NaCl solution quick washing, the intestine tissues were fixed in the 4% paraformaldehyde (BL539A, Biosharp) for 48 h. The fixed intestinal samples were carefully transferred to 75% alcohol for long-term preservation.

### Serum Biochemical Indices and Zn Contents in Different Tissues

The serum was taken out from the refrigerator at −80° C. and thawed at 4° C. 200 μL of serum samples were analyzed with the automatic biochemical analyzer (Rayto, Chemray 800). The main serum indicators (as the general health screens) included high-density lipoprotein cholesterol (HDL-C), low-density lipoprotein cholesterol (LDL-C), glucose (GLU), aspartate transaminase (AST), alanine transaminase (ALT), albumin (ALB) and total bilirubin (TBIL).

The freeze-dried tissue (gill, intestine, liver, and muscle) sample (0.05 g) was placed in the 15 mL centrifuge tube, digested with 3 mL of concentrated nitric acid, and then diluted with 2% nitric acid before measurements by ICP-MS (NexION 300X, PerkinElmer). Standard reference material for metals (Tuna Fish Flesh Homogenate, IAEA-436) was also concurrently digested, and the recovery was 97.3%.

### Histomorphological Section Preparation

The fixed intestine tissues were removed from the fixed liquid and then carefully trimmed with the ventilation cupboard. The trimmed tissues with different labels were placed in the dehydration box in the dehydrator (Donatello, DIAPATH) to dehydrate with gradient alcohol. The process was as follows: 75% alcohol 4 h, 85% alcohol 2 h, 90% alcohol 2 h, 95% alcohol 1 h, anhydrous ethanol I 30 min, anhydrous ethanol II 30 min, alcohol benzene 5˜10 min, xylene II 5˜10 min, 65° C. melting paraffin I1 h, 65° C. melting paraffin II 1 h, 65° C. melting paraffin Ill 1 h. The tissues were removed from the dehydration box and placed in the embedding frame of the embedding machine (JB-P5, Wuhan Junjie Electronics Co., Ltd), subsequently the frozen platform at −20° C. was used to cool the dewatering box. The solidified wax block was removed from the embedded frame and placed on the pathology slicer (RM2016, Shanghai Leica Instrument Co., Ltd) to obtain 4 μm slice thickness. The tissues were then flattened when the slice floated on the 40° C. warm water of the spreading machine. Finally, the tissues were picked up by the glass slides (Servicebio) and baked at 60° C. in the oven, and after the water-baked dried waxes were melted, these were taken out and stored at room temperature.

### In Situ Spatial Quantitative Identification

In situ spatial quantitative identification of HE sections were imaged and analyzed by tissue cytometry. Briefly, the images were obtained on the TissueFAXS quantitative imaging system (TissueGnostics, Vienna, Austria). The whole slide (75×25 mm²) was first scanned with a low-power×5 objective lenses to determine the position of the tissue on the slide and then scanned×20 high-power mirrors. The scanned files were imported into the strataquest professional organization single-cell quantitative analysis system (v.7.0.1.176) for image processing and analysis. Image processing included view and analysis of the panoramic scanned image of each slide. The generated image was exported as a gray-scale full-resolution TIFF file of each dye channel, and the cells were identified by using the unique biological in-situ single-cell flow scatter analysis function of tissue cytometry. Meanwhile, through the classifier function, Al automatically identified the special types of structures in tissues, such as intestinal villi and the circular muscle layer, the distance of goblet cells to the basal layer, and analyzed a variety of parameters including area and morphology to finally realize the single-cell analysis at the tissue level. Finally, the unique forward and backward backtracking verification mechanisms of tissue cytometry ensured the accuracy of recognition results.

### Bacterial 16S Ribosomal RNA Gene Sequencing

DNA samples from the intestine content (only mucosa without the muscularis) were isolated using the MP Fast® SPIN DNA Kit. Each replicated sample contained 6 fish, resulting in 18 fish per treatment group. DNA extracts were amplified using primers (338F_806R) for the V3-V4 region of the 16S rRNA gene. Procedures for the DNA extracts and PCR amplification and then illuminma Miseq sequencing are described as follows.

DNA extraction and PCR amplification: The quality of DNA extraction was determined using 1% agarose gel electrophoresis, and DNA concentration and purity were determined using NanoDrop2000. The DNA concentration and purity were determined using NanoDrop2000. The 16S rRNA gene V3-V4 variable region was amplified by PCR using 338F (5′-ACTCCTACGGGAGGCAGCAG-3′) and 806R (5′-GGACTACHVGGGTWTCTAAT-3′). The amplification procedure was as follows: 95° C. pre-denaturation for 3 min, 27 cycles (95° C. denaturation for 30 s, 55° C. annealing for 30 s, 72° C. extension for 30 s), followed by 72° C. stable extension for 10 min and finally storage at 4° C. (PCR instrument: ABI GeneAmp® Model 9700). FastPfu buffer 4 μL, 2.5 mM dNTPs 2 μL, upstream primer (5 uM) 0.8 μL, downstream primer (5 uM) 0.8 μL, TransStart FastPfu DNA polymerase 0.4 μL, template DNA 10 ng, ddH2O make up to 20 μL. 3 replicates for each sample.

Illumina Miseq sequencing: PCR products from the same sample were mixed and recovered using a 2% agarose gel. Fluorometer (Promega, USA) was used to quantify the recovered products. Library construction was performed using NEXTflex™ Rapid DNA-Seq Kit (Bioo Scientific, USA): (1) splice linkage; (2) removal of splice self-linked fragments using magnetic bead screening; (3) enrichment of library template using PCR amplification; (4) recovery of PCR products by magnetic beads to obtain the final library. Sequencing was performed using Illumina's Miseq PE300 platform (Shanghai Meiji Biomedical Technology Co., Ltd.).

For Illumina Miseq PE300, products were pooled by sequencing equimolar and paired-end sequences (2×300) to obtain the raw data. Please see description for raw data stitching and optimization. After the PE reads obtained by MiSeq sequencing were split, the double-ended reads were first quality controlled and filtered according to the sequencing quality. Meanwhile, according to the overlapping relationship between double-ended reads, the optimized data after quality control splicing were obtained. The QIIME (v1.9.1) 25 and QIIME2 (v2020.2) 21 pipelines were used for OTU- and ASV-based methods, respectively. The sequences were OTU clustered, and chimeras were removed based on 97% similarity using UPARSE software. Using QIIME2 software, the sequence noise reduction method (DADA2) was used to process the optimized data to obtain the representative sequence and abundance information of the ASV.

Raw data stitching and optimization: Fastp (version 0.20.0) software was used for quality control of the original sequencing sequence, and flash was used (version 1.2.7) software for splicing: (1) filter the bases with a mass value of less than 20 at the tail of reads and set a 50 bp window. If the average mass value in the window is less than 20, cut off the back-end bases from the window, filter the reads with a mass value of less than 50 bp after quality control and remove the reads containing N bases; (2) According to the overlap relationship between PE reads, paired reads are spliced into a sequence, and the minimum overlap length is 10 bp; (3) The maximum allowable mismatch ratio of overlap region of splicing sequence is 0.2, and the non-conforming sequences are screened; (4) The samples are distinguished according to the barcodes and primers at both ends of the sequence, and the sequence direction is adjusted. The allowable mismatch number of barcodes is 0 and the maximum primer mismatch number is 2.

Based on the representative sequences and abundance information of ASV and OTU, a series of statistical and visual analysis such as species taxonomy analyses (Veen diagram), α- and β-diversity, differential microbial analysis, and correlation analysis were carried out. Venn diagrams were generated using R software. The α-diversity indicators included the indices of Simpson and Shannon. The bray curtis distance method was used to determine the group differences (ANOSIM with a permutation count of 999) and then displayed in the principal coordinate analysis (PCoA). Species differences were analyzed using the Kruskal-Wallis rank-sum test, with the FDR multiple validations. Post-hoc test method (Tukey-Kramer) was used to compare the two groups, and the significance level of the comparison was 0.95. PICRUSt2 (Phylogenetic Investigation of Communities by Reconstruction of Unobserved States) was used to predict the functional abundance of KEGG orthologs based on marker gene (16S) sequences. Correlation analyses of the indicators between the different groups were performed in R and Pearson test. The mantel test was used for the analysis of the correlation between the intestinal microorganisms and environmental factors.

Real-Time Quantitative PCR (qPCR) Analysis

According to instructions, total RNA samples from the intestine were extracted using RNAiso Plus Kit (9109; Takara Biotech, Dalian, China). After passing the RNA quality test, reverse transcription generated single-stranded cDNA using a PrimeScripte RT reagent kit of total RNA. (Please see below description addressing the quality of RNA test). The RT-PCR assays were carried out in a quantitative thermal cycler (QuantStudio™ 5 Real-Time PCR Instrument, ABI, USA) in a final volume of 15 μL containing 7.5 μL 2×SYBR Green Realtime PCR Master Mix (Q711-02, Vazyme, Nanjing, China), 0.3 μL each of primers (10 μmol/L), 1 μL of cDNA mix and 5.9 μL Water-DEPC Treated Water (B501005, Sangon Biotech, Shanghai, China). Table 2 presents the primers for amplifying target genes. β-actin was used as an endogenous reference to normalize the template amount. The PCR in real-time was performed in the thermal cycler (ABI, Stepone Plus). The conditions of qPCR were as follows: 1 cycle, 95° C. for 30 s; 40 cycles, 95° C. for 10 s, 59° C. for 30 s, and ending at 4° C. During the detection, each sample was run in quartic, and PCR-grade water which replaced the template, was the negative control. Gene expression results were evaluated using the 2-ΔΔCT method.

The quality of RNA test: The quality of RNA was assessed using agarose gel electrophoresis. The quality of RNA was determined by a Nano Drop® ND-2000 spectrophotometer and agarose gel electrophoresis to determine whether it was suitable for cDNA synthesis. The absorption ratios of all samples were between 1.9 and 2.0 (260: 280 nm).

### Results

Macroscopic Growth Performance and Zn Accumulation after Dietary Exposure

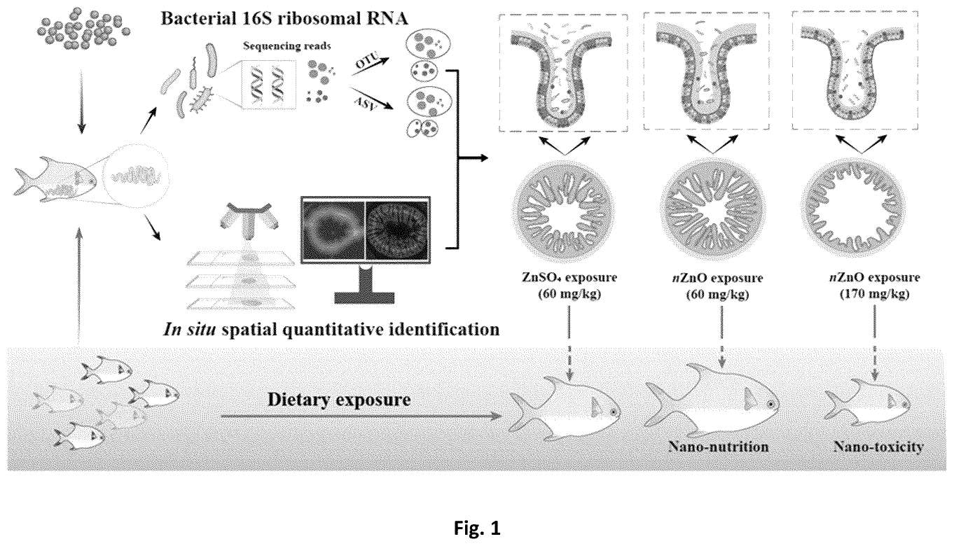

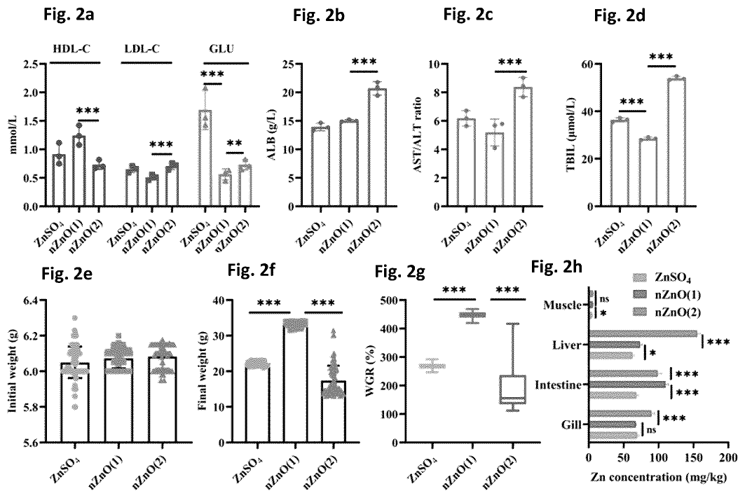

The serum biochemical indexes offish under different nZnO exposures for 5 weeks are shown in FIG. 2. At equal doses (60 mg/kg), there was no significant difference in serum index of fish exposed with ZnSO₄ and nZnO, such as HDL-C, LDL-C, ALB and AST/ALT ratio (p>0.05), but there was significant difference in glucose content and TBIL content (p<0.001). Low dose of dietary nZnO (60 mg/kg) exposure significantly increased the serum HDL-C contents (1.24 mmol/L) and decreased the serum LDL-C content (0.51 mmol/L), glucose content (0.56 mmol/L) (FIG. 1a), ALB content (15.03 g/L) (FIG. 1b), AST/ALT ratio (5.18) (FIG. 2c), and TBIL content (28.53 μmol/L) (FIG. 2d) of fish compared with those in high-dose nZnO (170 mg/kg) group (p<0.01). Low dose of dietary nZnO exhibited significant growth-promoting effects (final weight: 33.33 g, WGR: 448.21%) in fish, compared to equivalent dose of ZnSO₄ (final weight: 22.30 g WGR: 268.78%) or high dose of nZnO (final weight: 13.77 g, WGR: 124.47%) (p<0.001) (FIGS. 2e to g). Dietary nZnO exposure (60 mg/kg), compared with ZnSO₄ group, significantly promoted the Zn accumulation in the intestine and liver of fish (p<0.001). A high dose of dietary nZnO (170 mg/kg) further promoted the Zn accumulation in the gill (90.4 μg/g), and liver (155.8 μg/g) (FIG. 2h).

### Bacterial 16S Ribosomal RNA Gene Sequencing Based on ASV and OTU Analysis

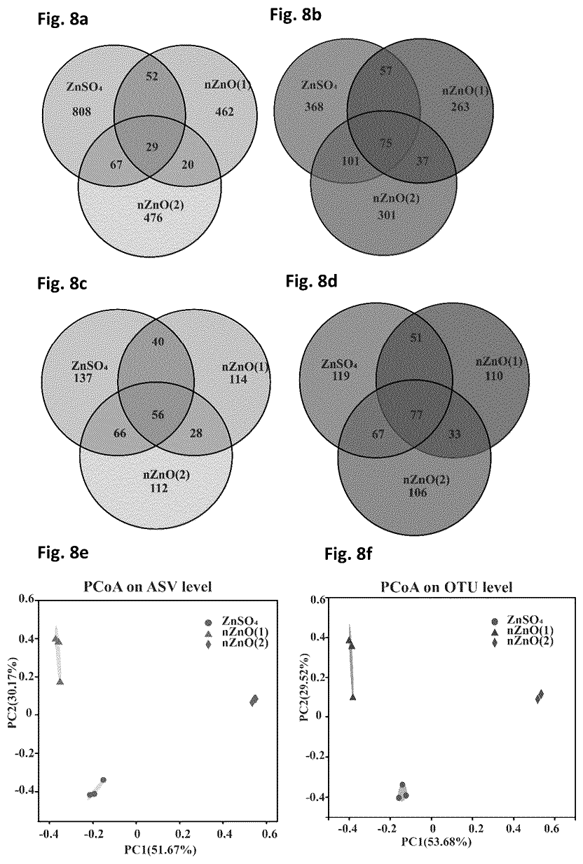

Bacterial 16S ribosomal RNA gene sequencing of intestine yielded an average of 6.82×104 valid reads, average length 425 bp, and total bases 2.90×107 bp (average Q30: 92.63%, average Q20: 97.52%). Two methods (ASV- and OTU-based method) were used for cluster analysis of optimized sequences (FIGS. 8a to 8f). ASV clustering analysis was able to match more microorganisms either at the ASV level or at the genus level, with no change in the original data of the sequences in our study (FIGS. 8a to 8f). Veen diagram illustrated that 60 mg/kg dietary ZnSO₄ increased the unique reads of microorganisms at ASV level (unique: 808) and genus level (unique: 137) (FIG. 8a). However, different doses of nZnO had positive effects on fish intestinal ASV levels (60 mg/kg nZnO: 462, 170 mg/kg nZnO: 476) (FIG. S2a) and genus levels (60 mg/kg nZnO:114, 170 mg/kg nZnO: 112) (FIG. 8c) (SI Appendix). There was no significant effect on the number of endemic species of microorganisms. Different doses of dietary nZnO did not affect the intestinal ASV levels (60 mg/kg nZnO: 462, 170 mg/kg nZnO: 476) and genus levels (60 mg/kg nZnO: 114, 170 mg/kg nZnO: 112), but had an obvious effect on the number of unique microorganisms. Compared to the OTU-method, the ASV-method identified a larger number of microorganisms in our study (FIG. 8b & 8d). In validating the datasets, a significant separation (ASV- and OTU-based method) was observed between microorganisms with ZnSO₄ exposure, 60 mg/kg nZnO exposure, and 170 mg/kg nZnO exposure for taxonomic profiles (FIGS. 8e to 8-f).

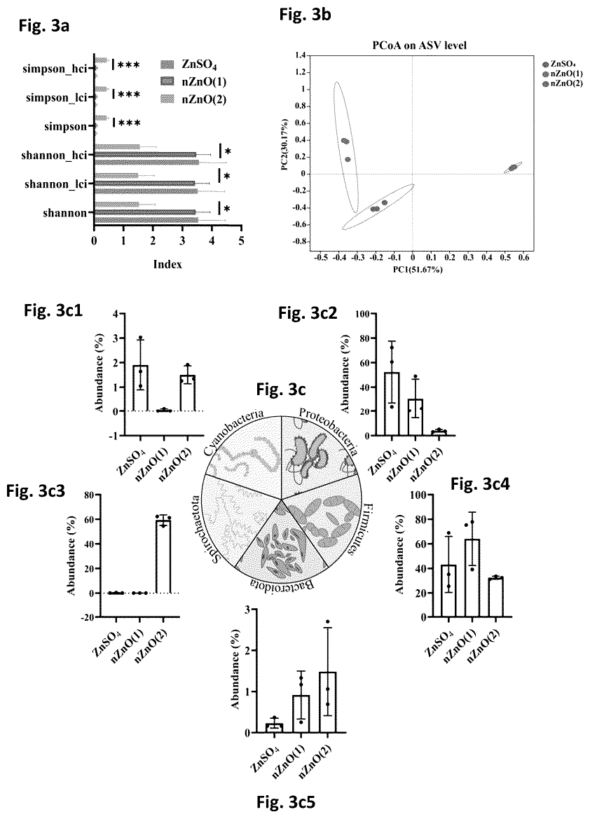

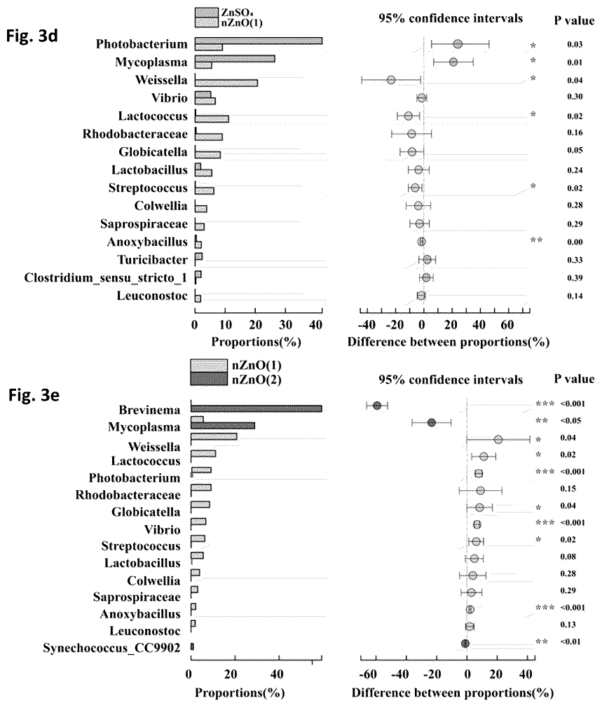

The ASV-based method was then used when exploring the influence of nZnO on intestinal microorganisms. Indices of Shannon and Simpson indices were used to evaluate the species diversity in intestinal samples. 60 mg/kg nZnO had a higher Shannon index and lower Simpson index, suggesting that 60 mg/kg nZnO exposure increased the species of microorganisms at the phylum level and provided a relatively stable community structure for the intestine of golden pompano (FIG. 3a). The PCoA results (confidence ellipse) showed that intestine microorganisms of fish exposed to different dietary Zn were differentiated into three groups (FIG. 3b). We then analyzed the microbial species composition and differential microorganisms to determine how dietary nZnO exposure affected the intestinal function. The intestinal microorganisms were concentrated in five phyla, namely Proteobacteria, Firmicutes, Bacteroidota, Spirochaetota, and Cyanobacteria (FIG. 3c). Proteobacteria, Firmicutes and Cyanobacteria were mostly microorganisms in the fish intestine after exposure to dietary ZnSO₄. The intestinal microorganisms exposed to 60 mg/kg nZnO mostly belonged to Proteobacteria, Firmicutes and Bacteroidota at the phyla level. At 170 mg/kg nZnO, the intestinal microorganisms mostly belonged to Firmicutes and Spirochaetota at the phyla level. The results of genus-level differential microorganisms showed that dietary ZnSO₄ exposure resulted in significantly enriched Photobacterium and Mycoplasma at genus-level in fish intestine (FIG. 3d). A high concentration of nZnO significantly promoted the colonization of genus-level microorganisms Brevinema and Mycoplasma (p<0.001) (FIG. 3e). In contrast, 60 mg/kg dietary nZnO resulted in significant colonization of Weissella, Lactococcus, Rhodobacteraceae, Globicatella, Lactobacillus, Streptococcus, Colwellia, Saprospiraceae, Anoxybacillus, Vibrio, and Synechococcus-CC9902 the fish intestine (p<0.05) (FIG. 3e).

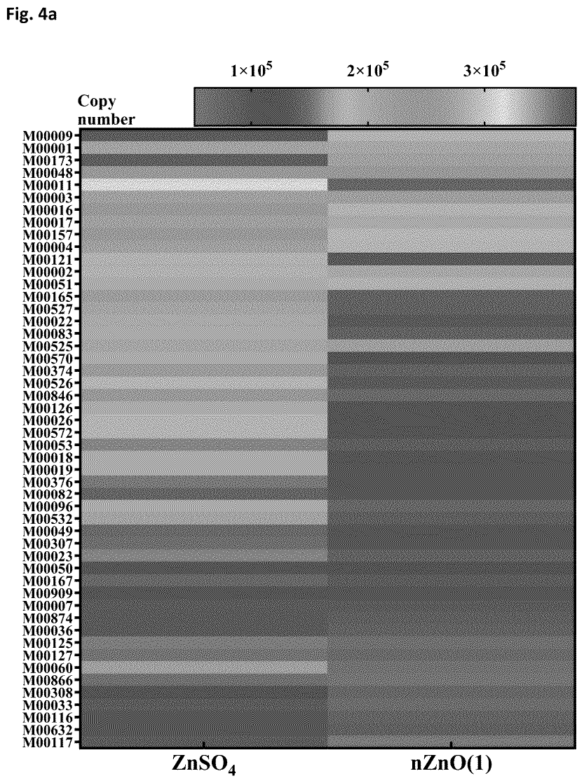

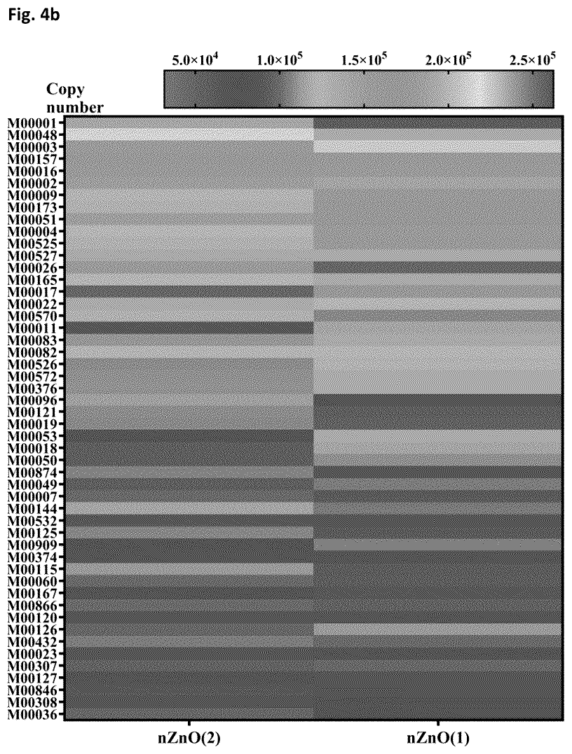

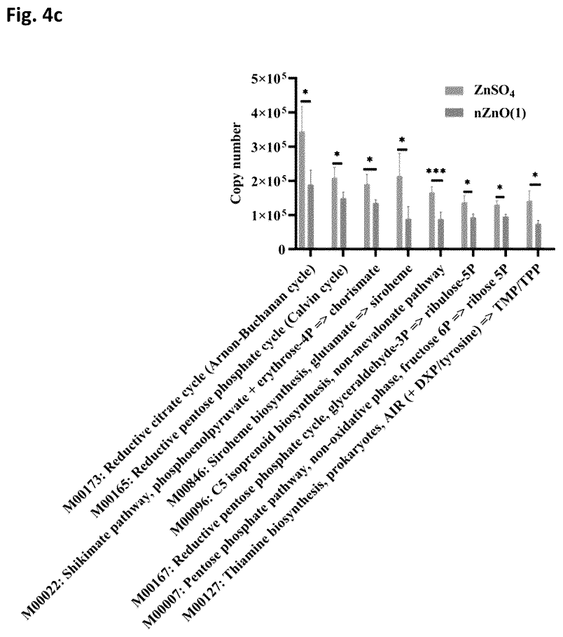

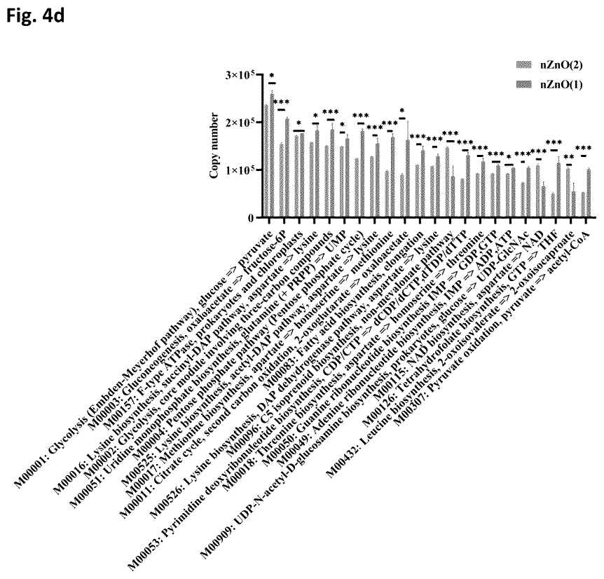

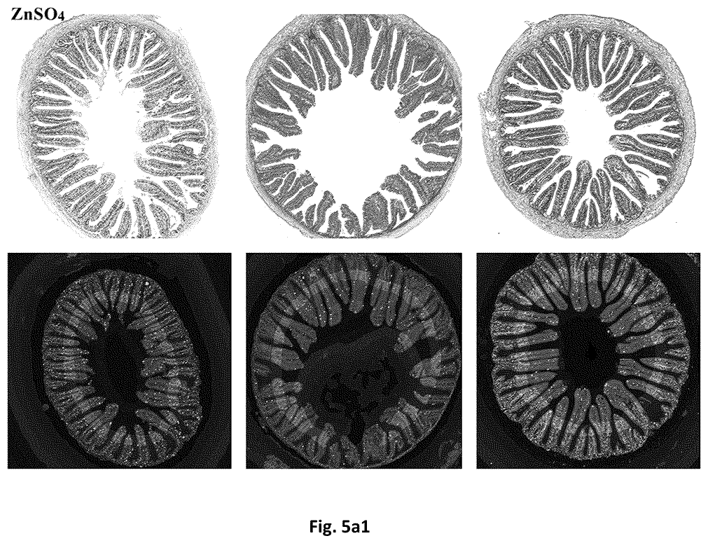

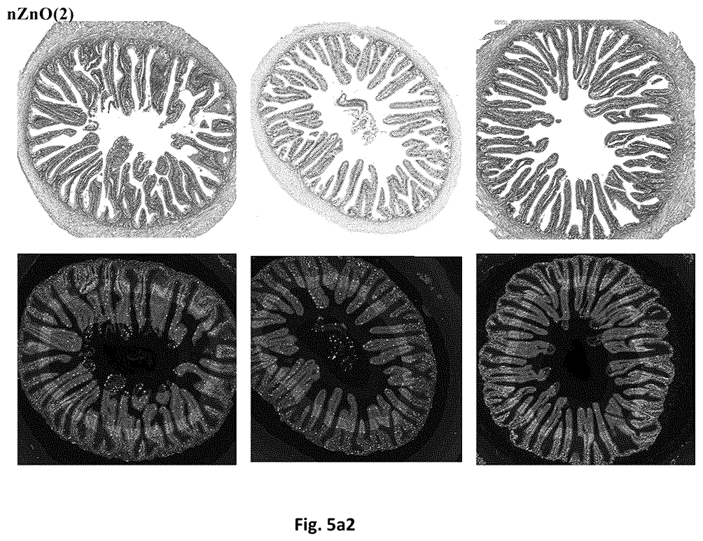

PICRUSt2 was used to compare the sequences of ASVs with internal reference sequences, placed the ASVs into corresponding reference trees, inferred the copy number of each ASV gene family, and then predicted the gene content of each ASV to determine the abundance of each sample gene family. The gene family information was then compared with the KEGG functional database to obtain the corresponding functional and abundance information in each sample. 50 signaling pathways were compared in the KEGG database and enriched with the TOP 30 KEGG pathways (FIGS. 4a to 4d). Microorganisms colonized in the fish intestine after 60 mg/kg ZnSO₄ exposure were mainly involved in the reductive citrate cycle (Arnon-Buchanan cycle), the Calvin cycle, and C5 isoprenoid biosynthesis (non-mevalonate pathway) (p<0.05). In our study, microbial functions from 60 mg/kg nZnO group mainly focused on substance metabolism such as glycolysis (embden-meyerhof pathway), gluconeogenesis, lysine biosynthesis DAP pathway, uridine monophosphate, among others (p<0.05) (FIGS. 4a & 4c). The microbial functions in the intestine of fish exposed to 170 mg/kg nZnO were C5 isoprenoid biosynthesis (non-mevalonate pathway), NAD biosynthesis, and leucine biosynthesis (p<0.05) (FIGS. 4c to 4d).

### In Situ Quantitative Spatial Analysis, Gene Expression, and Correlation Analysis

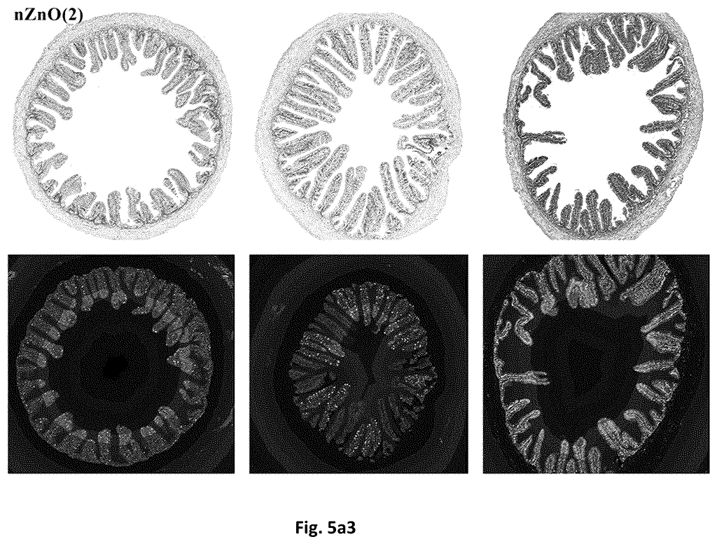

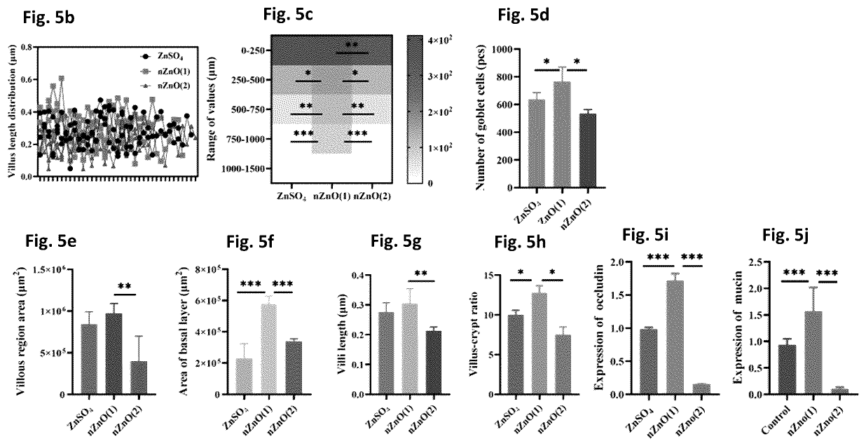

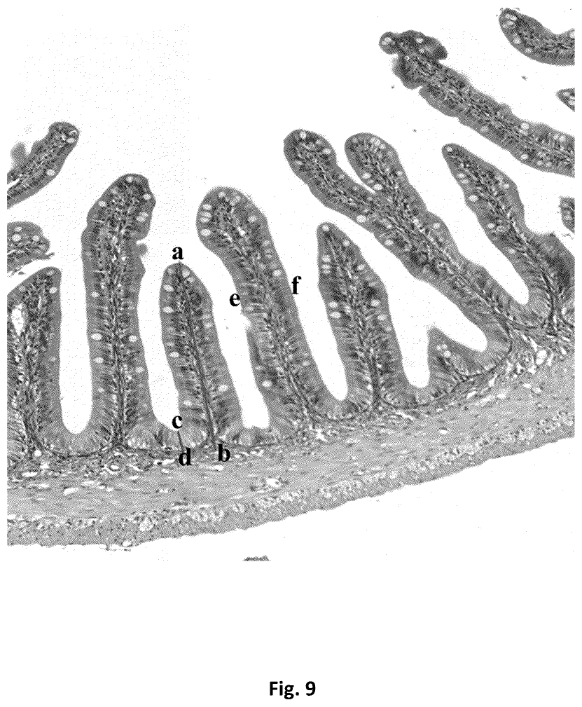

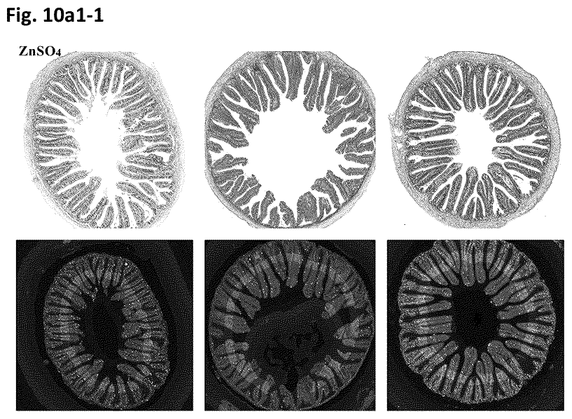

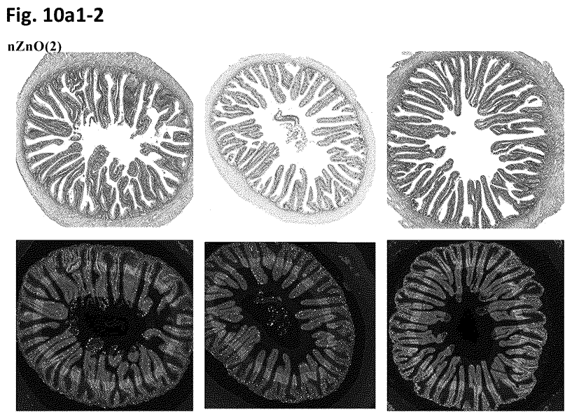

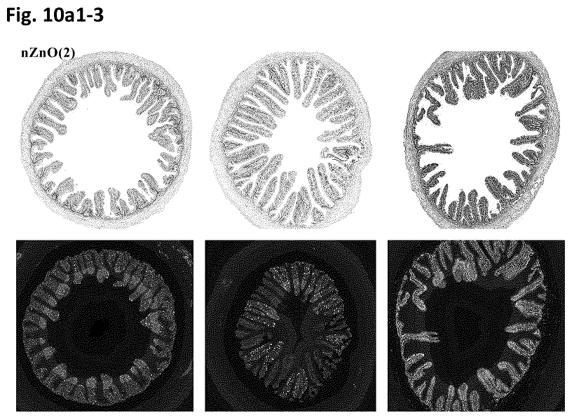

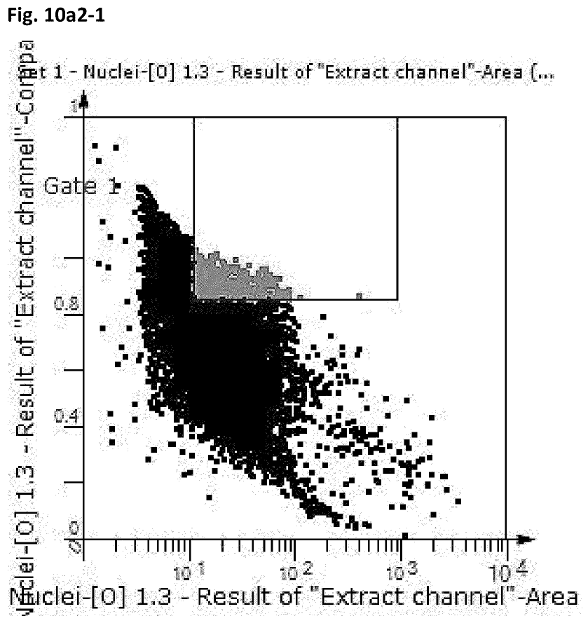

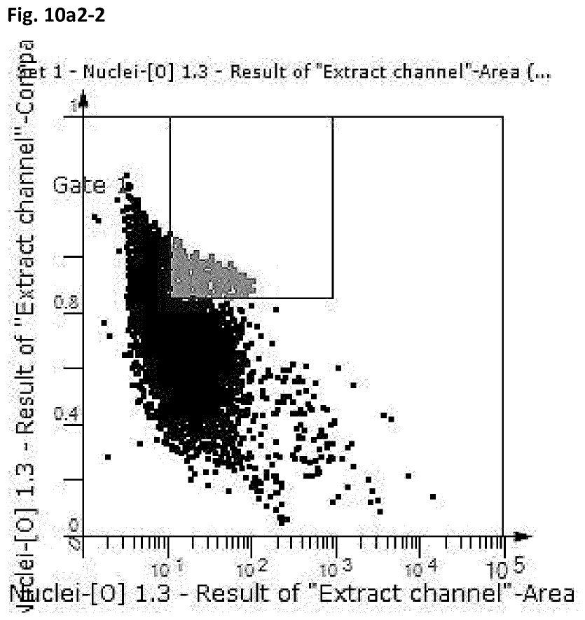

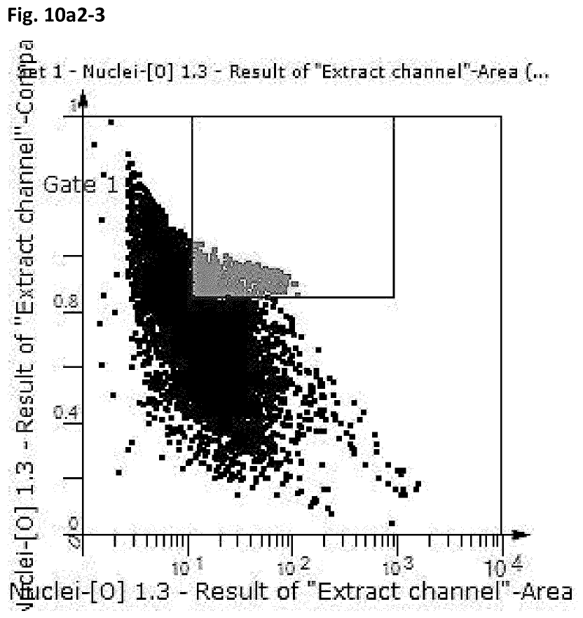

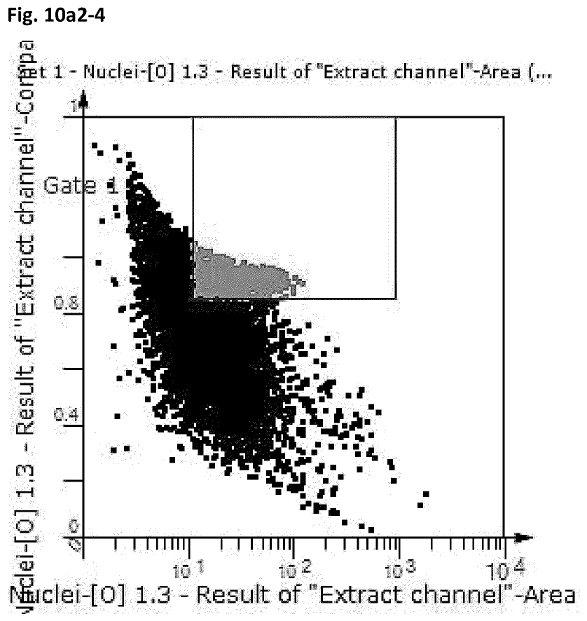

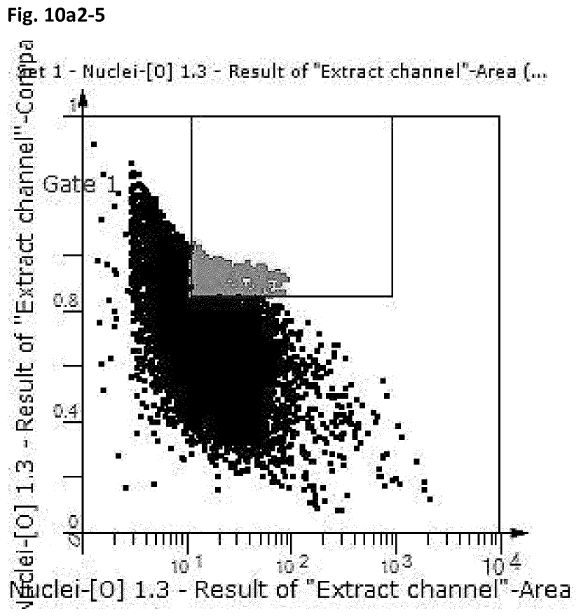

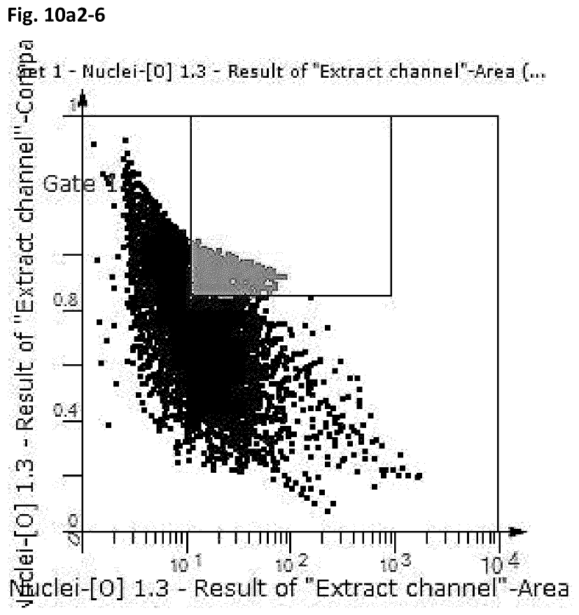

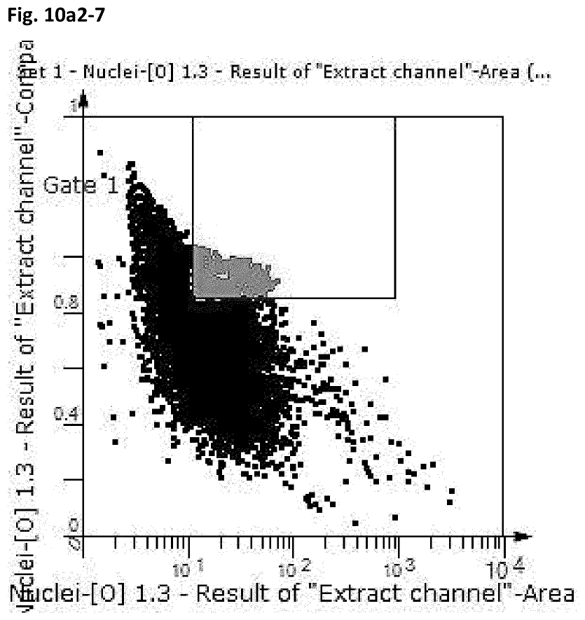

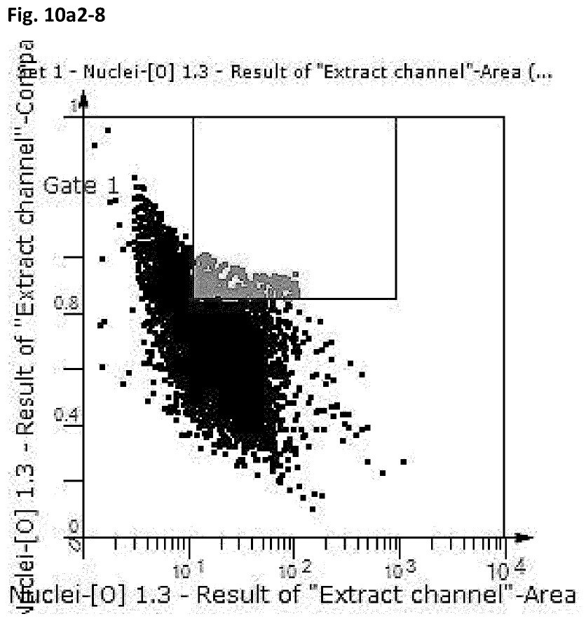

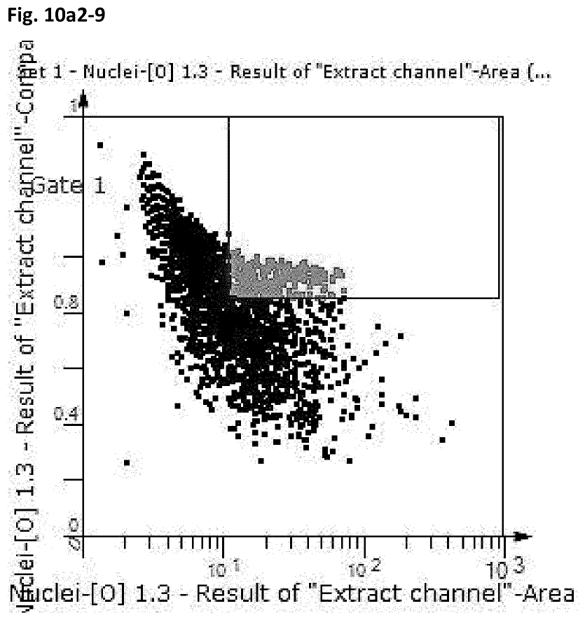

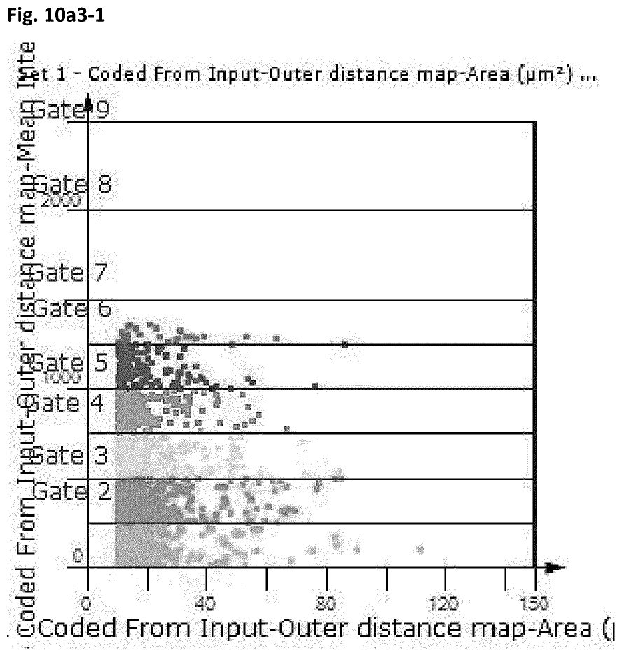

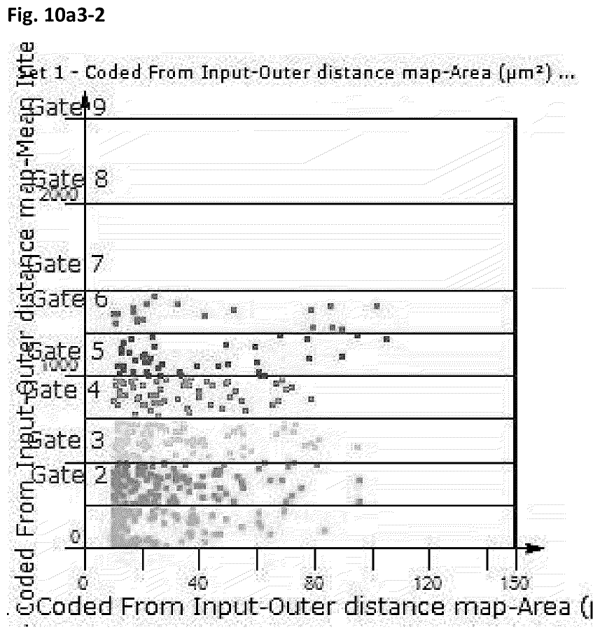

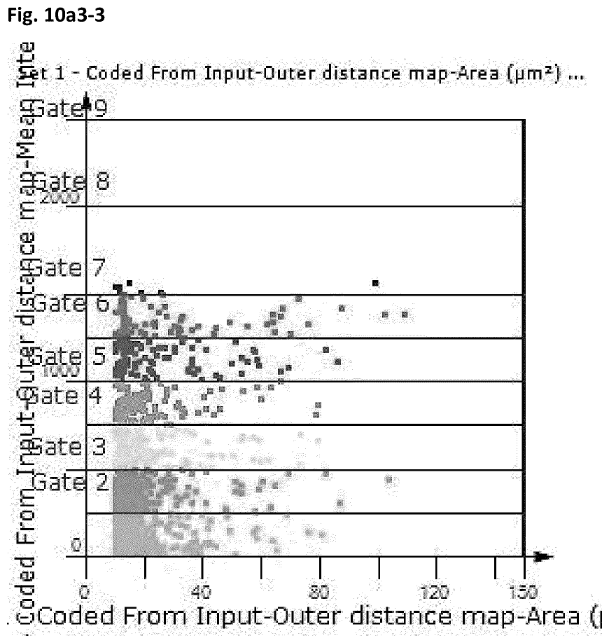

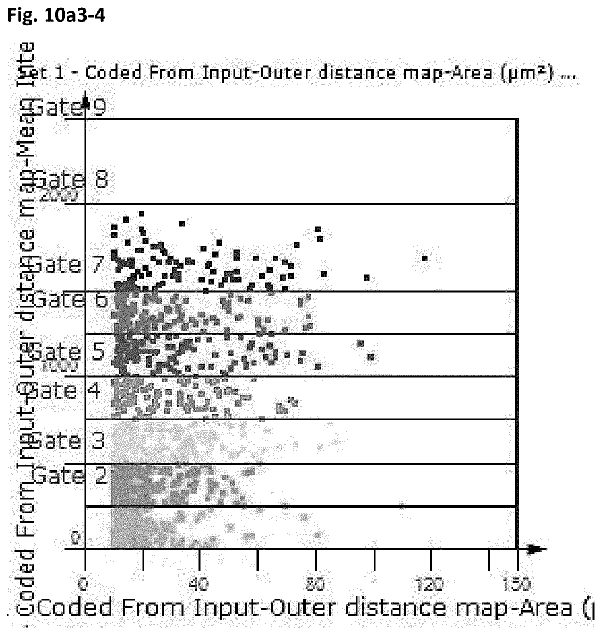

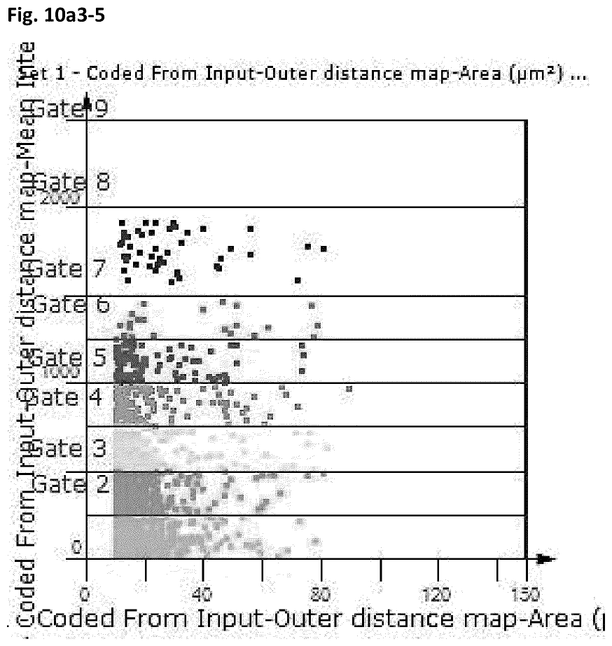

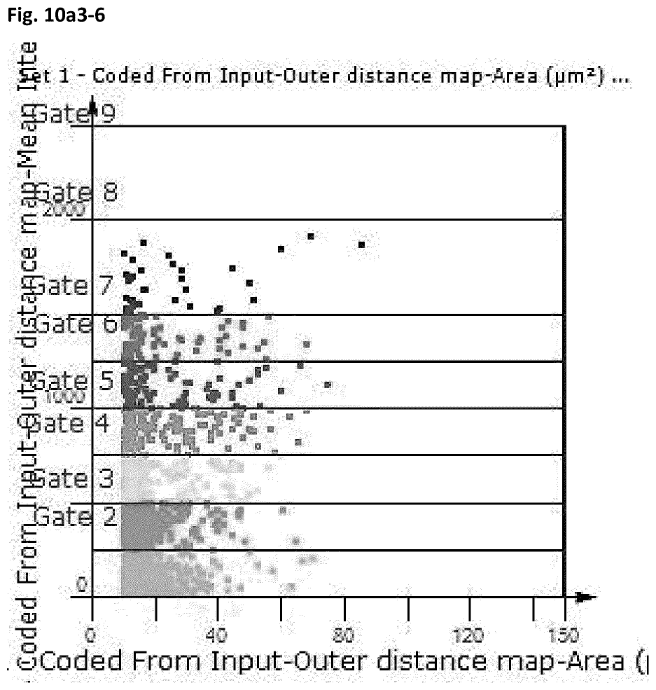

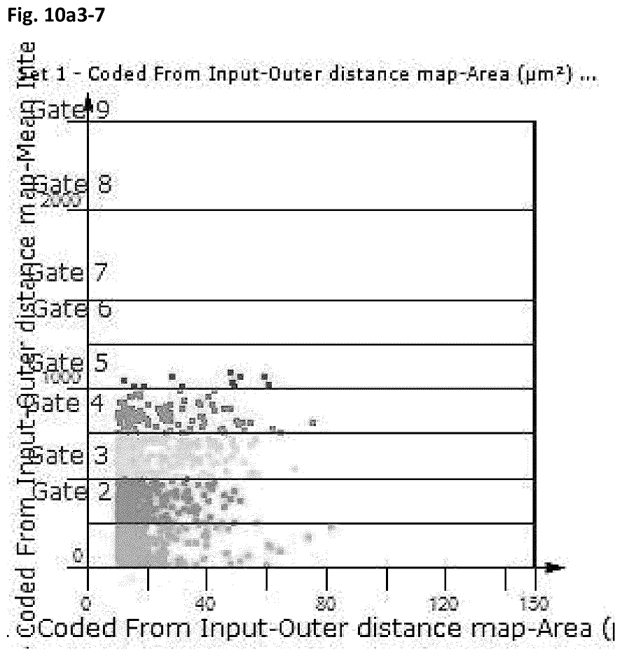

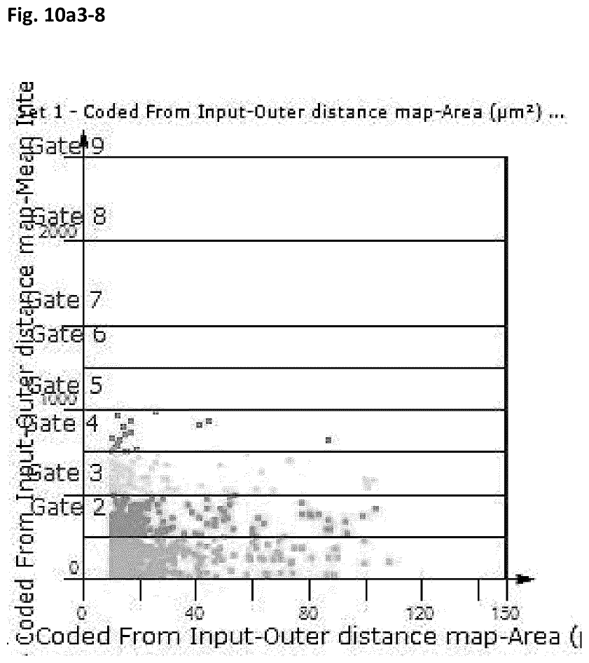

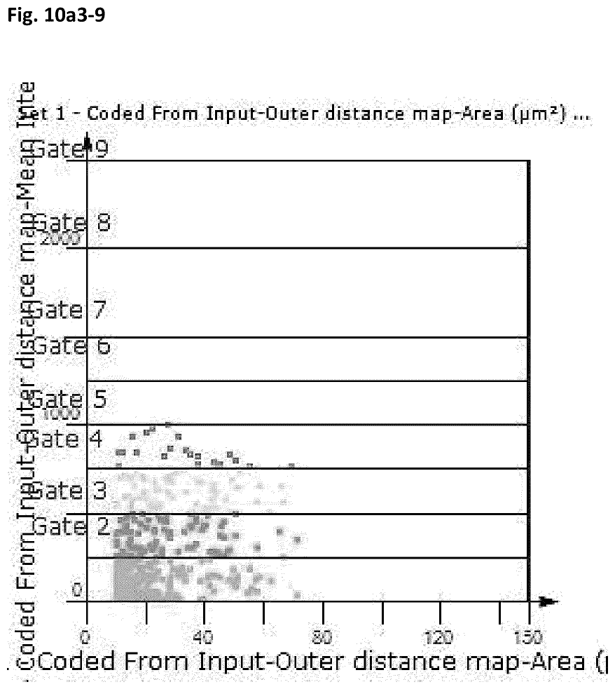

The identified intestinal structure indicators based on in situ quantitative spatial analysis are shown in FIGS. 5a1 to 5a3 and 5b to 5j. Three HE sections were randomly selected for each group for identification (FIG. 9). Statistically, the obtained quantitative data was analyzed (FIGS. 10a1-1 to 10a13, FIGS. 10a2-1 to 10a2-1 and FIGS. 10a3-1 to 10a3-9) and compared the effects of nZnO and ZnSO₄ exposure on the intestinal structure (FIG. 4b). After exposure, changes in the fish villi intestine ranged from 0.05-0.33 μm (60 mg/kg ZnSO₄ exposure), 0.12-0.35 μm (60 mg/kg nZnO) and 0.07-0.21 μm (170 mg/kg nZnO), respectively. At 60 mg/kg nZnO exposure, the total number of goblet cells and the number of goblet cells in different ranges were significantly higher than those in the other two groups (p<0.05) (FIGS. 5c & 5d). Compared with other groups, 60 mg/kg nZnO exposure significantly increased the area of basal layer of fish intestine (p<0.001) (FIG. 4e & f), average villi length (p<0.01) (FIG. 5g), intestinal/crypt ratio (p<0.05) (FIG. 5h). Key gene expression verification results showed that 60 mg/kg nZnO significantly up-regulated the mRNA expression of occludin (FIG. 5i) and mucin (FIG. 5j).

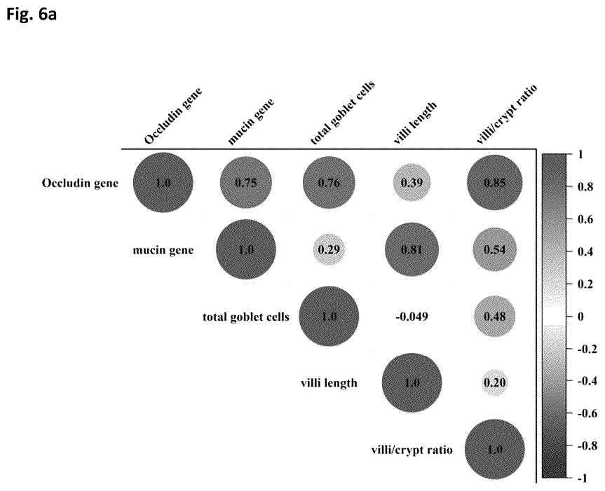

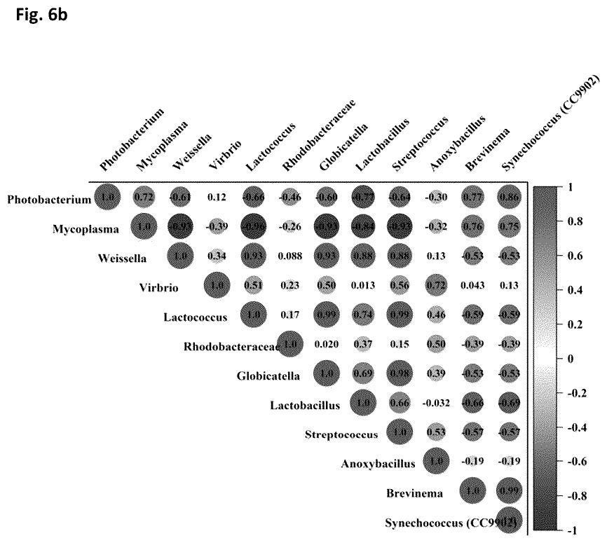

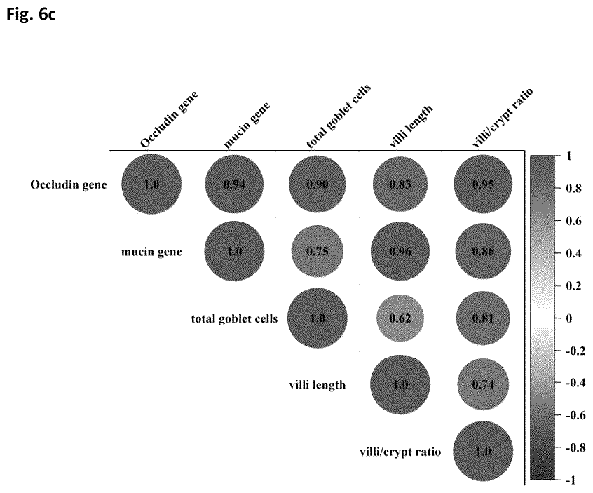

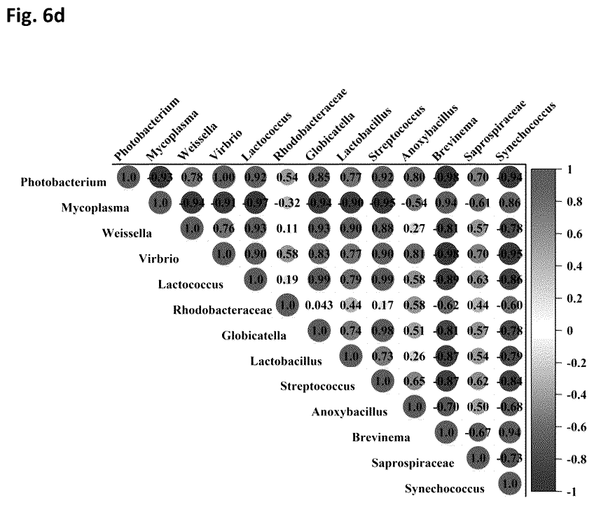

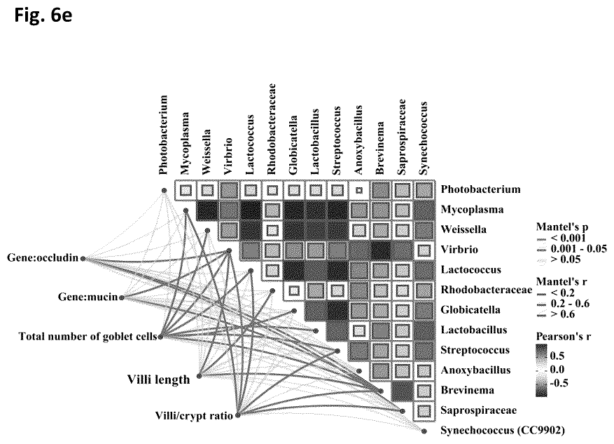

The results of correlation analysis showed that at 60 mg/kg for both ZnSO₄ and nZnO, the gene expression of occludin was positively correlated with gene mucin expression (r=0.75), the total number of goblet cells (r=0.76) and villi/crypt ratio (r=0.85) (FIG. 6a). While, the gene expression of mucin was only positively correlated with villi length (r=0.81), but the correlation with other intestinal structure indicators was low (FIG. 6a). The abundance of Mycoplasma at the genus level was highly and negatively correlated with Weissella (r=−0.93), Lactococcus (r=−0.96), Globicatella (r=−0.93), Lactobacillus (r=−0.84), Streptococcus (r=−0.93). The abundances of Photobacterium (r=0.77, 0.86) and Mycoplasma (r=0.76, 0.75) were highly and positively correlated with Brevinema and Synechococcus_CC9902, respectively (FIG. 6b). FIG. 6c shows that the correlation between ocludin gene and intestinal structural indicator was enhanced after dietary nZnO exposure, including mucin gene expression (r=0.94), total number of goblet cells (r=0.90), villi length (r=0.83), and villi/crypt ratio (r=0.95). The mucin expression was highly and positively correlated with the total number of goblet cell (r=0.75), villi length (r=0.96) and villi/crypt ratio (r=0.86) (FIG. 6c). The total number of goblet cell (r=0.81) and the villi length (r=0.74) were both highly and positively correlated with villi/crypt ratio. The abundance of Brevinema was only positively correlated with Mycoplasma (r=0.94), which was negatively correlated with other microorganisms (FIG. 5d). The abundance of Synechococcus_CC9902 was only positively correlated with Mycoplasma (r=0.86) and Brevinema (r=0.94), which was negatively correlated with other microorganisms (FIG. 6d). While, the abundance of Mycoplasma was negatively correlated with Weissella (r=−0.94), Vibrio (r=−0.91), Lactococcus (r=−0.97), Globicatella (r=−0.94), Lactobacillus (r=−0.90) and Streptococcus (r=−0.95) (FIG. 6d). The mantel test was used to interpret the intestinal structure indexes with multiple intestinal microbial abundance, based on the correlation between intestinal microorganisms and intestinal structure (FIG. 6e). The results showed that intestinal microbial abundance were significantly correlated with the changes of intestinal structure (r>0.6, p<0.05). Vibrio abundance was negatively correlated with the villi/crypt ratio (p<0.001) (FIG. 6e), which indicated that the value of villi/crypt ratio decreased with increasing Vibrio abundance.

High Bioavailability of nZnO had Positive Effects on Intestinal Health Through Microorganisms and Structure

In this study, the significantly accumulated Zn concentration in the intestine illustrated that 60 mg/kg of dietary nZnO released more Zn than ZnSO₄ in fish body, thus providing the physiological functions in fish. The core microorganisms identified in our study were the same species commonly found in other fishes, but there were differences in species abundance. The most abundant microorganisms (Photobacterium and Mycoplasma) colonized in the 60 mg/kg ZnSO₄ exposure group carried out metabolic activities of nutrients (glucose, lipid and protein) through the reductive citrate cycle (Arnon-buchanan cycle) pathway, and then efficiently produced ATP through oxidative phosphorylation. An active Calvin cycle allowed microorganisms to produce glucose under anaerobic conditions. This also suggested that the increased serum glucose content in the ZnSO₄ group was a result of intestinal microorganisms involved in the Calvin cycle. The activated C5 isoprenoid biosynthesis (MEP) is a key metabolic pathway for the synthesis of terpenoids (isoprenoid organisms) essential for the survival of pathogenic microorganisms, which made it easier for harmful microorganisms to parasitize the fish intestine. Therefore, combined with microbial colonization, it was possible that the intestinal homeostasis of marine fish was pro-inflammatory after the dietary ZnSO₄ exposure.

In contrast, nZnO (60 mg/kg) promoted the colonization of Lactic-acid bacilli, e.g., Weissella, Lactococcus, Lactobacillus, and Streptococcus, which were probiotics. These probiotics had a common biological function to ensure the normal digestion and metabolism of the intestine, nutrient supply, detoxification, and promoted intestinal peristalsis to provide immune and nutrition support to the intestine. The presence of probiotic bacteria was a direct indication that 60 mg/kg nZnO significantly promoted the fish growth. Meanwhile, all these probiotics were closely related to the Zn level in the intestinal tract. Lactobacillus, Weissella, and Leuconostoc were lactic acid bacteria with the ability to adsorb metals. The presence of these lactic acid bacteria was able to circumvent the effect of the intestinal barrier and reduce the oxidative stress. Removal of Zn from intestinal tract by colonized Streptococcus in fish intestine could result in secretion of lipolytic enzymes 39, which may facilitate the Zn absorption. Rhodobacteraceae are aquatic bacteria and related to the detoxification of metals. Also, microorganisms colonized after 60 mg/kg nZnO exposure had a higher capacity for Zn adsorption, which may also be directly responsible for the accumulation of Zn in the intestinal tract (positive correlation).

In addition, the serum results showed that 60 mg/kg nZnO exposure decreased the LDL-C content and increased the HDL-C content of fish serum compared with the ZnSO₄ group, strongly suggesting that nZnO more easily affected the lipid metabolism, with an obvious scavenging effect in reducing the LDL content in fish. Exposure to nZnO significantly decreased the serum glucose content in our study. Marine fish are relatively poor in utilizing carbohydrates compared with other vertebrates, primarily due to the insufficient insulin secretion. Our results implied that ZnO NPs might affect the release of insulin, prolonging the hypoglycemic action of insulin to regulate the blood glucose decreasing. ZnO nanoparticles could interact with polar and charged amino acids on the surface of insulin protein. Furthermore, size of NPs may be important leading to different biological effects. For example, the smaller size (40 nm) of NPs may have a greater impact on protein structure of organisms.

Colonization with intestine microbes could also alter intestine structure. The villus area and villus/crypt ratio of the intestine reflected the digestion and absorption of intestine for metal ions and nutrients (amino acids, glucose, inorganic salts). The intestinal villus area, villus/crypt ratio, basal layer area and number of goblet cell all reduced in the fish intestine exposed to ZnSO₄ group. The lower digestive and absorptive capacity of intestine may explain why the ZnSO₄ group did not significantly promote the weight gain in the fish. The results also showed that 60 mg/kg nZnO exposure consolidated the intestinal structure of fish through strengthening the intestinal villi structure. nZnO played a facilitating role in developing and strengthening intestinal villi structures in fish, as reported in other studies. In the study, ZnSO₄ was less effective than the equivalent dose of nZnO in promoting the secretion of goblet cells. The mucus layer was constantly consumed and replenished, and as the first immune line of the intestine, it limited the contact between bacteria and intestinal epithelium, while providing nutrients and adhesion sites for the microorganisms. Goblet cells played a key role in intestinal immunity by secreting mucin, which formed a mucus layer attached to the epithelial layer, thereby isolating and controlling the colonization and invasion of intestinal microorganisms.

60 mg/kg dietary nZnO induced goblet cells to migrate from the bottom to the surface along with epithelial cells. The contents of cells were discharged through apical plasma secretion to renew the goblet cells in villi and the removal of harmful substances. Our results also showed that the number of goblet cells in the 750-1000 μm layer after exposure to 60 mg/kg nZnO increased significantly. Key gene validation also confirmed that the high expression of occludin and mucin genes ensured the intrinsic immune system of the intestine while providing nutrients to the microorganisms colonizing the intestine, which may be an important mechanism for Zn homeostasis in the fish gut environment.

Toxicity of High-Dose of nZnO Manifested in Activation of Pro-Inflammatory Response

The effects of different dietary doses of nZnO on fish intestine health were analyzed. Our study indicated that at 170 mg/kg nZnO, Brevinema and Mycoplasma were significantly enriched, which were also the common microbial species (pro-inflammatory microorganisms) in the intestine of marine fish. Brevinema was an important potential pathogen causing enteritis in seahorse Hippocampus kuda, and Mycoplasma was involved in pentose phosphate pathway (glucose metabolism) and lipid metabolism pathways in mice. The functional analysis of significantly enriched microorganisms showed that C5 isoprenoid biosynthesis (non-mevalonate pathway), NAD biosynthesis and Leucine biosynthesis were activated by the high dose (170 mg/kg) of nZnO exposure. Brevinema and Mycoplasma also activated the C5 isoprenoid biosynthesis (non-mevalonate pathway) pathway, which was used to synthesize large amounts of terpenoids required for their survival. The NAD biosynthesis activated by pro-inflammatory bacteria promoted the synthesis of nicotinamide adenine dinucleotide (NAD+), which promoted the secretion of pro-inflammatory factors by cells. Thus, high dose of nZnO activated the immune response of intestinal mucus by increasing the abundance of Brevinema and Mycoplasma, which was confirmed by the results of correlation analysis in our study. In turn, the strength of intestinal mucus immune function was directly derived from the intestinal mucus layer. The lower villus height, villus area, and goblet cell numbers indicated the presence of numerous pro-inflammatory microorganisms in the intestine of fish after 170 mg/kg dietary exposure. Further, the significant down-regulation of occludin and mucin gene expression indicated that such response produced damage to the mucus layer function, while causing toxic effects on normal nutrient metabolism and growth of fish.

Indicators of ALB, AST, ALT, and TBIL were used to evaluate the metabolism, cell injury degree and liver detoxification ability. ALB was only produced by the liver and the serum ALB concentration was a marker to reflect the synthetic function of liver and chronic liver injury. Serum ALB was the main transporter of Zn in vertebrates, although it was only weakly and nonspecifically bound with these metals. The serum ALB concentration in fish decreased after 60 mg/kg nZnO exposure compared with other groups, suggesting that nZnO reduced the liver metabolic damage in the study. Amino transferases (ALT and AST) were released after liver cell necrosis or liver cell membrane injury and elevated in serum during acute liver injury. AST/ALT ratio commonly reflected the degree of liver cell injury. In the study, 170 mg/kg nZnO increased the AST/ALT ratio of fish, confirming that this dosage caused more acute liver injury in fish. Serum TBIL depended on the dynamic balance between bilirubin production and hepatocyte clearance. A decreased ability to clear the damaged liver cells or increased bile duct release resulted in an increased serum TBIL level.

The present invention has revealed the regulatory mechanism of intestinal microbiota and structure mediated by Zn nanoparticles which subsequently improved the health and growth performance of fish by integrated analysis of microbial omics and in situ quantitative spatial. The present invention also illustrates that ZnO nanoparticles are more effective in releasing Zn by increasing the bioavailability to affect the intestinal microbiota and structure. Optimal dose of nZnO (60 mg/kg) improved the health and growth of marine fish, where high-dose of nZnO (170 mg/kg) resulted in toxicity. However, such optimal vs. toxicity dose may also be related to the size of NPs in the fish diets. Compared to ZnSO₄, 60 mg/kg nZnO exhibited significant nutritional effects on fish in the marine environment. Apparent growth data and serum indicators directly confirmed such effect, while low dose of nZnO exposure induced a large number of beneficial microorganisms to colonize the intestine, with microbial functions focusing on the digestion and absorption of nutrients, as well as accelerating the renewal of goblet cells to achieve the regulation of gut health homeostasis. In contrast, the biological toxicity of high dose dietary nZnO was probably due to the colonization of pro-inflammatory microorganisms, the destruction of intestinal structure (reduction in the number of goblet cells and the height and area of the villi) and the damage to the intestinal mucus layer, which eventually leads to abnormal serum indicators and low growth capacity.

Although the afore-described experiments to support the use of 60 mg/kg nZnO as a workable dose in a fish formulation, further experiments have also indicated the workable dose can actually range from 60-93.5 mg/kg nZnO, or preferably 74.68-93.35 mg/kg nZnO, or more preferably substantially 74.68 mg/kg. The Zn content is thus 48.25-75 mg/kg, or 60-75 mg/kg, or substantially 60 mg/kg, respectively. With regard to the size of the nZnO particles, the workable size is 10-15 nm in diameter, or preferably 10-28 nm in diameter.

It should be understood that certain features of the invention, which are, for clarity, described in the content of separate embodiments, may be provided in combination in a single embodiment. Conversely, various features of the invention which are, for brevity, described in the content of a single embodiment, may be provided separately or in any appropriate sub-combinations. It is to be noted that certain features of the embodiments are illustrated by way of non-limiting examples.

TABLE 1
Feed formulation and proximate composition analysis of diet

| | ZnSO₄ group | Zn NPs group | Zn NPs g [symbol] |
|---|---|---|---|
| Ingredients (mg/kg) | (ZnSO₄) | (nZnO(1)) | (nZnO( [symbol] |
| Casein ¹ | 350 | 350 | 350 |
| Fermented soybean meal ¹ | 180 | 180 | 180 |
| Cassava starch ¹ | 160 | 160 | 60 |
| α-Starch ¹ | 30 | 30 | 30 |
| Soybean oil ¹ | 40 | 40 | 40 |
| Soybean lecithin ¹ | 90 | 90 | 90 |
| Choline chloride ¹ | 20 | 20 | 20 |
| Ca(H₂PO₃)₂ ¹ | 20 | 20 | 20 |
| Antioxidant ¹ | 10 | 10 | 10 |
| Vitamin premix ¹ | 20 | 20 | 20 |
| Mineral premix (Zn-free) ³ | 20 | 20 | 20 |
| Attractant ² | 10 | 10 | 10 |
| ZnSO₄ (mg) ⁴ | 50 | 0 | 0 |
| ZnO NPs (mg) ⁴ | 0 | 50 | 150 |

Proximate composition (dry matter)

| | | | |
|---|---|---|---|
| Moisture (%) | 8.40 ± 0.02 | 8.40 ± 0.07 | 8.60 ± [symbol] |
| Crude protein (%) | 43.52 ± 1.28 | 43.52 ± 1.04 | 43.52 |
| Crude lipid (%) | 11.60 ± 0.14 | 11.60 ± 0.10 | 11.60 |
| Ash (%) | 5.87 ± 0.00 | 5.87 ± 0.04 | 5.57 ± [symbol] |
| Nominal Zn (mg/kg) | 50.0 | 50.0 | 150.0 |
| [symbol] easured Zn (mg/kg) | 60.2 ± 1.35 | 60.1 ± 1.40 | 170.2 |

¹ All these ingredients were purchased from Qingdao Fulin Biochemistry Co. Ltd.
² The attractant was purchased from Bayer (Sichuan) Animal health Co. Ltd.
³ Mineral premix (Zn-free): mineral premix provided the following per kg of diet: NaF 4 mg; KI 1.6 mg; 1% CoCl₂•6H₂O 100 mg; FeSO₄•H₂O 160 mg; MgSO₄•7H₂O 2.4 g; Ca(H₂PO₄)₂•H₂O 6.0 g; CuSO₄•5H₂O 20 mg; MnSO₄•H₂O 120 mg; NaCl 200 mg, Zeolite power 30.90 g.
⁴ Ingredients were purchased from Aladdin Reagent (Shanghai) Co., Ltd. The food pellets were prepared by mixing the nanomaterials with the dry ingredients.
Error bars represent the standard deviation of the replicates (n = 3). [symbol]
indicates data missing or illegible when filed

TABLE 2
Forward and reverse primers for qPCR analysis

| | SEQ ID NO./ | SEQ ID NO./ |
|---|---|---|
| | Forward primer | Reverse primer |
| Genes | (5′-3′) | (3′-5′) |
| Occludin | 1/ATCAGCGACCAGA | 4/CCGAAGTTCTTT |
| | TGCACAA 0 | GCTGTGCC |
| Mucin | 2/CGTACCTACCCGT | 5/GACCCTCAAGCC |
| | CATGTCC | AAGACTCG |
| β-Actin | 3/CACTCTTCCAGCC | 6/GTACAGGTCTTT |
| | TTCCTTC | GCGGATGT |

The following references are incorporated in their entirety and a skilled person is considered to be aware of disclosure of these references.
A. Maage and K. Julshamn, Assessment of zinc status in juvenile Atlantic salmon (Salmo salar) by measurement of whole body and tissue levels of zinc, Aquaculture, 1993, 117, 179-191.
P. Antony Jesu Prabhu, J. W. Schrama and S. J. Kaushik, Mineral requirements of fish: a systematic review, Reviews in Aquaculture, 2016, 8, 172-219.
Y. Nishito and T. Kambe, Absorption mechanisms of iron, copper, and zinc: an overview, Journal of Nutritional Science and Vitaminology, 2018, 64, 1-7.
A. Scherzad, T. Meyer, N. Kleinsasser and S. Hackenberg, Molecular mechanisms of zinc oxide nanoparticle-induced genotoxicity, Materials, 2017, 10, 1427.
B. D. Johnston, T. M. Scown, J. Moger, S. A. Cumberland, M. Baalousha, K. Linge, R. van Aerle, K. Jarvis, J. R. Lead and C. R. Tyler, Bioavailability of nanoscale metal oxides TiO2, CeO2, and ZnO to fish, Environmental Science & Technology, 2010, 44, 1144-1151.
A. Ahamed, L. Liang, M. Y. Lee, J. Bobacka and G. Lisak, Too small to matter? Physicochemical transformation and toxicity of engineered nTiO2, nSiO2, nZnO, carbon nanotubes, and nAg, Journal of Hazardous Materials, 2021, 404, 124107.
J. Hou, Y. WU, X. Li, B. Wei, S. Li and X. Wang, Toxic effects of different types of zinc oxide nanoparticles on algae, plants, invertebrates, vertebrates and microorganisms, Chemosphere, 2018, 193, 852-860.
A. Sirelkhatim, S. Mahmud, A. Seeni, N. H. M. Kaus, L. C. Ann, S. K. M. Bakhori, H. Hasan and D. Mohamad, Review on zinc oxide nanoparticles: antibacterial activity and toxicity mechanism, Nano-Micro Letters, 2015, 7, 219-242.
D. D. Schleder, J. R. Da Rosa, A. M. Guimaraes, F. Ramlov, M. Maraschin, W. Q. Seiffert, F. do Nascimento Vieira, L. Hayashi and E. R. Andreatta, Brown seaweeds as feed additive for white-leg shrimp: effects on thermal stress resistance, midgut microbiology, and immunology, Journal of Applied Phycology, 2017, 29, 2471-2477.
M. Anjugam, B. Vaseeharan, A. Iswarya, N. Gobi, M. Divya, M. P. Thangaraj and P. Elumalai, Effect of β-1, 3 glucan binding protein based zinc oxide nanoparticles supplemented diet on immune response and disease resistance in Oreochromis mossambicus against Aeromonas hydrophila, Fish & Shellfish Immunology, 2018, 76, 247-259.
A. H. Mondal, T. Behera, P. Swain, R. Das, S. N. Sahoo, S. S. Mishra, J. Das and K. Ghosh, Nano zinc vis-à-vis inorganic Zinc as feed additives: Effects on growth, activity of hepatic enzymes and non-specific immunity in rohu, Labeo rohita (Hamilton) fingerlings, Aquaculture Nutrition, 2020, 26, 1211-1222.
G.-H. Chen, C.-C. Song, T. Zhao, C. Hogstrand, X.-L. Wei, W.-H. Lv, Y.-F. Song and Z. Luo, Mitochondria-Dependent Oxidative Stress Mediates ZnO Nanoparticle (ZnO NP)-Induced Mitophagy and Lipotoxicity in Freshwater Teleost Fish, Environmental Science & Technology, 2022, 56, 4, 2407-2420.
E. G. Canli, A. Dogan and M. Canli, Serum biomarker levels alter following nanoparticle (Al2O3, CuO, TiO2) exposures in freshwater fish (Oreochromis niloticus), Environmental Toxicology and Pharmacology, 2018, 62, 181-187.
G. Sharma and K. M. Merz, Formation of the Metal-Binding Core of the ZRT/IRT-like Protein (ZIP) Family Zinc Transporter, Biochemistry, 2021, 60, 2727-2738.
B. J. Shaw and R. D. Handy, Physiological effects of nanoparticles on fish: a comparison of nanometals versus metal ions, Environment International, 2011, 37, 1083-1097.
S. Ahlawat, P. Kumar, H. Mohan, S. Goyal and K. K. Sharma, Inflammatory bowel disease: tri-directional relationship between microbiota, immune system and intestinal epithelium, Critical Reviews in Microbiology, 2021, 47, 254-273.
D. Boyle, N. J. Clark, T. L. Botha and R. D. Handy, Comparison of the dietary bioavailability of copper sulphate and copper oxide nanomaterials in/ex vivo gut sacs of rainbow trout: effects of low pH and amino acids in the lumen, Environmental Science: Nano, 2020, 7, 1967-1979.
Y. Li, W.-X. Wang and H. Liu, Gut-microbial adaptation and transformation of silver nanoparticles mediated the detoxification of Daphnia magna and their offspring, Environmental Science: Nano, 2022, 9, 361-374.
F. Martino, S. Varricchio, D. Russo, F. Merolla, G. Ilardi, M. Mascolo, G. O. dell'Aversana, L. Califano, G. Toscano and G. De Pietro, A machine-learning approach for the assessment of the proliferative compartment of solid tumors on hematoxylin-eosin-stained sections, Cancers, 2020, 12, 1344.
A. E. Pérez-Cobas, L. Gomez-Valero and C. Buchrieser, Metagenomic approaches in microbial ecology: an update on whole-genome and marker gene sequencing analyses, Microbial Genomics, 2020, 6.
E. Bolyen, J. R. Rideout, M. R. Dillon, N. A. Bokulich, C. C. Abnet, G. A. Al-Ghalith, H. Alexander, E. J. Alm, M. Arumugam and F. Asnicar, Reproducible, interactive, scalable and extensible microbiome data science using QIIME 2, Nature Biotechnology, 2019, 37, 852-857.
J. N. Martinson, N. V. Pinkham, G. W. Peters, H. Cho, J. Heng, M. Rauch, S. C. Broadaway and S. T. Walk, Rethinking gut microbiome residency and the Enterobacteriaceae in healthy human adults, The ISME Journal, 2019, 13, 2306-2318.
J. Wang, A. Wang and W.-X. Wang, Evaluation of nano-ZnOs as a novel Zn source for marine fish: importance of digestive physiology, Nanotoxicology, 2017, 11, 1026-1039.
AOAC, Official Methods of Analysis of Official Analytical Chemists International, 16th ed. Association of Official Analytical Chemists, Arlington, V A., 1995, 12-469.
J. G. Caporaso, J. Kuczynski, J. Stombaugh, K. Bittinger, F. D. Bushman, E. K. Costello, N. Fierer, A. G. Peha, J. K. Goodrich and J. I. Gordon, QIIME allows analysis of high-throughput community sequencing data, Nature Methods, 2010, 7, 335-336.
K. J. Livak and T. D. Schmittgen, Analysis of relative gene expression data using real-time quantitative PCR and the 2-ΔΔCT method, Methods, 2001, 25, 402-408.
B. Pardesi, A. M. Roberton, K. C. Lee, E. R. Angert, D. I. Rosendale, S. Boycheva, W. L. White and K. D. Clements, Distinct microbiota composition and fermentation products indicate functional compartmentalization in the hindgut of a marine herbivorous fish, Molecular Ecology, 2022, 31, 2494-2509.
Y. Dong, Y. Li, P. He, Z. Wang, S. Fan, Z. Zhang, X. Zhang and Q. Xu, Gut microbial composition and diversity in four ophiuroid species: divergence between suspension feeder and scavenger and their symbiotic microbes, Frontiers in Microbiology, 2021, 12, 645070.
C. Breusing, K. J. Osborn, P. R. Girguis and A. T. Reese, Composition and metabolic potential of microbiomes associated with mesopelagic animals from Monterey Canyon, ISME Communications, 2022, 2, 117.
A. Mall, J. Sobotta, C. Huber, C. Tschimer, S. Kowarschik, K. Batnik, M. Mergelsberg, M. Boll, M. Hugler and W. Eisenreich, Reversibility of citrate synthase allows autotrophic growth of a thermophilic bacterium, Science, 2018, 359, 563-567.
C. Auger, R. Vinaik, V. D. Appanna and M. G. Jeschke, Beyond mitochondria: Alternative energy-producing pathways from all strata of life, Metabolism, 2021, 118, 154733.
G. R. Navale, M. S. Dharne and S. S. Shinde, Metabolic engineering and synthetic biology for isoprenoid production in Escherichia coli and Saccharomyces cerevisiae, Applied Microbiology and Biotechnology, 2021, 105, 457-475.
H. Van Doan, S. H. Hoseinifar, E. Ringo, M. Ángeles Esteban, M. Dadar, M. A. Dawood and C. Faggio, Host-associated probiotics: a key factor in sustainable aquaculture, Reviews in Fisheries Science & Aquaculture, 2020, 28, 16-42.
G. Santos, M. Libanori, S. Pereira, J. Ferrarezi, M. Ferreira, T. Soligo, E. Yamashita, M. Martins and J. Mouriño, Probiotic mix of Bacillus spp. and benzoic organic acid as growth promoter against Streptococcus agalactiae in Nile tilapia, Aquaculture, 2023, 566, 739212.
C. M. Thomas and J. Versalovic, Probiotics-host communication: modulation of signaling pathways in the intestine, Gut Microbes, 2010, 1, 148-163.
J. Liedtke and W. Vahjen, In vitro antibacterial activity of zinc oxide on a broad range of reference strains of intestinal origin, Veterinary Microbiology, 2012, 160, 251-255.
I. C. Starke, R. Pieper, K. Neumann, J. Zentek and W. Vahjen, The impact of high dietary zinc oxide on the development of the intestinal microbiota in weaned piglets, FEMS Microbiology Ecology, 2014, 87, 416-427.
W. Vahjen, R. Pieper and J. Zentek, Bar-coded pyrosequencing of 16S rRNA gene amplicons reveals changes in ileal porcine bacterial communities due to high dietary zinc intake, Applied and Environmental Microbiology, 2010, 76, 6689-6691.
D. Liu, Z. Mao, Z. An, L. Ma and Z. Lu, Significantly improved Escherichia coli tolerance and accumulation of Cd2+, Zn2+ and Cu2+ expressing Streptococcus thermophilus StGCS-GS with high glutathione content, Annals of Microbiology, 2014, 64, 961-967.
C. A. David, J. Galceran, C. Rey-Castro, J. Puy, E. Companys, J. Salvador, J. Monne, R. Wallace and A. Vakourov, Dissolution kinetics and solubility of ZnO nanoparticles followed by agnes, The Journal of Physical Chemistry C, 2012, 116, 11758-11767.
L. Birmes, H. M. Freese and J. Petersen, RepC_soli: a novel promiscuous plasmid type of Rhodobacteraceae mediates horizontal transfer of antibiotic resistances in the ocean, Environmental Microbiology, 2021, 23, 5395-5411.
M. Banaszak, I. Góma and J. Przyslawski, Zinc and the Innovative Zinc-α2-Glycoprotein Adipokine Play an Important Role in Lipid Metabolism: A Critical Review, Nutrients, 2021, 13, 2023.
B. S. Kamalam, F. Medale and S. Panserat, Utilisation of dietary carbohydrates in farmed fishes: new insights on influencing factors, biological limitations and future strategies, Aquaculture, 2017, 467, 3-27.
D. A. Stone, Dietary carbohydrate utilization by fish, Reviews in Fisheries Science, 2003, 11, 337-369.
F. Chimienti, Zinc, pancreatic islet cell function and diabetes: new insights into an old story, Nutrition Research Reviews, 2013, 26, 1-11.
G. M. Noguchi and M. O. Huising, Integrating the inputs that shape pancreatic islet hormone release, Nature Metabolism, 2019, 1, 1189-1201.
G. Hosseinzadeh, A. Maghari, S. M. F. Farnia and A. A. Moosavi-Movahedi, Interaction mechanism of insulin with ZnO nanoparticles by replica exchange molecular dynamics simulation, Journal of Biomolecular Structure and Dynamics, 2018, 36, 3623-3635.
H. Kaya, F. Aydin, M. Gürkan, S. Yilmaz, M. Ates, V. Demir and Z. Arslan, Effects of zinc oxide nanoparticles on bioaccumulation and oxidative stress in different organs of tilapia (Oreochromis niloticus), Environmental Toxicology and Pharmacology, 2015, 40, 936-947.
K. Giannousi, G. Geromichalos, D. Kakolyri, S. Mourdikoudis and C. Dendrinou-Samara, Interaction of ZnO nanostructures with proteins: In vitro fibrillation/antifibrillation studies and in silico molecular docking simulations, ACS Chemical Neuroscience, 2020, 11, 436-444.
C. Wang, L. Zhang, W. Su, Z. Ying, J. He, L. Zhang, X. Zhong and T. Wang, Zinc oxide nanoparticles as a substitute for zinc oxide or colistin sulfate: Effects on growth, serum enzymes, zinc deposition, intestinal morphology and epithelial barrier in weaned piglets, PloS one, 2017, 12, e0181136.
L. Chupani, H. Niksirat, V. Lünsmann, S.-B. Haange, M. von Bergen, N. Jehmlich and E. Zuskova, Insight into the modulation of intestinal proteome of juvenile common carp (Cyprinus carpio L.) after dietary exposure to ZnO nanoparticles, Science of The Total Environment, 2018, 613, 62-71.
E. E. Nyström, B. Martinez-Abad, L. Arike, G. M. Birchenough, E. B. Nonnecke, P. A. Castillo, F. Svensson, C. L. Bevins, G. C. Hansson and M. E. Johansson, An intercrypt subpopulation of goblet cells is essential for colonic mucus barrier function, Science, 2021, 372, eabb1590.
P. Paone and P. D. Cani, Mucus barrier, mucins and gut microbiota: the expected slimy partners?, Gut, 2020, 69, 2232-2243.
A. Parker, L. Vaux, A. M. Patterson, A. Modasia, D. Muraro, A. G. Fletcher, H. M. Byrne, P. K. Maini, A. J. Watson and C. Pin, Elevated apoptosis impairs epithelial cell turnover and shortens villi in TNF-driven intestinal inflammation, Cell Death & Disease, 2019, 10, 1-13.
R. Wang, X. Pan and Y. Xu, Altered intestinal microbiota composition associated with enteritis in yellow seahorses Hippocampus kuda (Bleeker, 1852), Current Microbiology, 2020, 77, 730-737.
J. Yu, J. Guo, W. Tao, P. Liu, E. Shang, Z. Zhu, X. Fan, J. Shen, Y. Hua and K. Y. Zhu, Gancao-Gansui combination impacts gut microbiota diversity and related metabolic functions, Journal of Ethnopharmacology, 2018, 214, 71-82.
I. Shats, J. G. Williams, J. Liu, M. V. Makarov, X. Wu, F. B. Lih, L. J. Deterding, C. Lim, X. Xu and T. A. Randall, Bacteria boost mammalian host NAD metabolism by engaging the deamidated biosynthesis pathway, Cell Metabolism, 2020, 31, 564-579. e567. A. Gavrić, M. Ribnikar, L. Šmid, B. Luzar and B. Štabuc, Fat burner-induced acute liver injury: Case series of four patients, Nutrition, 2018, 47, 110-114.
R. Garcia-Martinez, P. Caraceni, M. Bernardi, P. Gines, V. Arroyo and R. Jalan, Albumin: pathophysiologic basis of its role in the treatment of cirrhosis and its complications, Hepatology, 2013, 58, 1836-1846.
R. Spinella, R. Sawhney and R. Jalan, Albumin in chronic liver disease: structure, functions and therapeutic implications, Hepatology International, 2016, 10, 124-132.
B. J. SCOTT and A. Bradwell, in Protides of the Biological Fluids, Elsevier, 1984, vol. 31, pp. 15-18.
S. T. Trisak, P. Doumgdee and B. M. Rode, Binding of zinc and cadmium to human serum albumin, The International Journal of Biochemistry, 1990, 22, 977-981.
P. N. Newsome, R. Cramb, S. M. Davison, J. F. Dillon, M. Foulerton, E. M. Godfrey, R. Hall, U. Harrower, M. Hudson and A. Langford, Guidelines on the management of abnormal liver blood tests, Gut, 2018, 67, 6-19.
H. Nyblom, E. Björnsson, M. Simrén, F. Aldenborg, S. Almer and R. Olsson, The AST/ALT ratio as an indicator of cirrhosis in patients with PBC, Liver International, 2006, 26, 840-845.
T. A. Woreta and S. A. Alqahtani, Evaluation of abnormal liver tests, Medical Clinics, 2014, 98, 1-16.
S. Agrawal, R. K. Dhiman and J. K. Limdi, Evaluation of abnormal liver function tests, Postgraduate medical journal, 2016, 92, 223-234.

What is claimed is:

1. A method of improving health of fish, comprising a step of feeding the fish with a fish feed, wherein the fish feed in its dried state has 60-93.35 mg/kg of zinc oxide (ZnO) particles.

2. A method as claimed in claim 1, wherein the improving health of fish is at least one of increasing body weight of fish, improving microbiota composition in the intestines of the fish, improving intestinal structures and intestinal health of the intestines of the fish, and regulating metabolism of glucose and lipid in the fish.

3. A method as claimed in claim 2, wherein the improving microbiota composition is improving probiotics colonization of Lactic-acid bacilli spp.

4. A method as claimed in claim 2, wherein the improving microbiota composition is increasing presence of the combination of microorganisms from the phyla of Proteobacteria, Firmicutes and Bacteroidota.

5. A method as claimed in claim 2, wherein the improving microbiota composition is promoting colonization of the combination of microorganisms of Weissella, Lactococcus, Rhodobacteraceae, Globicatella, Lactobacillus, Streptococcus, Colwellia, Saprospiraceae, Anoxybacillus, Vibrio, and Synechococcus-CC9902.

6. A method as claimed in claim 2, wherein the improving structure of the intestines of the fish is accelerating renewal of goblet cells in villus of the intestines, increasing height and/or area of the villus in the intestines, and/or increasing the number of goblet cells in the intestines.

7. A method as claimed in claim 1, wherein the ZnO particles are zinc oxide nano-particles (nZnO), and wherein the fish feed in its dried state has 74.68-93.35 mg/kg of nZnO.

8. A method as claimed in claim 7, wherein the fish feed in its dried state has substantially 74.68 mg/kg.

9. A method as claimed in claim 1, wherein the fish feed in its dried state has 48.25-75 mg/kg of zinc (Zn) from the ZnO particles, or preferably 60-75 mg/kg, or more preferably substantially 60 mg/kg.

10. A method as claimed in claim 7, wherein the nZnO have an average diameter of 10-45 nm.

11. A method as claimed in claim 10, wherein the nZnO particles have an average diameter of 10-28 nm.

12. A method as claimed in claim 1, wherein the feed is free of zinc sulphate (ZnSo₄).

13. A method as claimed in claim 1, wherein the fish feed contains protein selected from casein and soybean.

14. A method as claimed in claim 1, comprises feeding the fish with the fish feed twice a day, and maintaining the water temperature at 29-32° C., the oxygen level at 6.8-7.2 mg/L, and the salinity at 28-30%.

15. Use of zinc oxide nano-particles (nZnO) for the preparation of a ZnO-containing fish feed for improving health of fish, wherein the fish feed in its dried state has a nZnO content of 60-93.35 mg/kg and thus has a Zn content of 48.25-75 mg/kg, and the nZnO particles have an average diameter of 10-45 nm.

16. Use as claimed in claim 15, wherein the improving health of fish is at least one of increasing body weight of fish, improving microbiota composition in the intestines of the fish, improving structure of the intestines of the fish, and regulating the glucose and lipid metabolism of the fish.

17. A method of preparing a fish feed for improving health of fish, comprising the steps of:
preparing a predetermined amount of fish feed,
preparing a predetermined amount of zinc oxide (ZnO) particles,
adding the ZnO particles to an alcohol medium so that the ZnO particles is suspended in the alcohol medium and thus forming a ZnO-containing suspension additive,
sonicating the ZnO-containing suspension additive, and
adding the ZnO-containing suspension additive to the fish feed such that the fish feed, in its dried state, has a 74.68-93.35 mg/kg of the ZnO particles.

18. A method as claimed in claim 17, wherein the ZnO particles are ZnO nano-particles (nZnO), and the fish feed in its dried state has substantially 74.68 mg/kg of the nZnO, and the nZnO have an average diameter of 10-45 nm.

19. A fish feed comprising 60-93.35 mg/kg of zinc oxide (ZnO) particles.

20. A fish feed as claimed in claim 19, wherein the ZnO particles are ZnO nano-particles (nZnO) and have an average diameter of 10-45 nm.


SEQUENCE LISTING (6 sequences)

SEQ ID NO: 1 - DNA, 20 bp, synthetic construct
  source 1..20: mol_type = other DNA
atcagcgaccagatgcacaa

SEQ ID NO: 2 - DNA, 20 bp, synthetic construct
  source 1..20: mol_type = other DNA
cgtacctacccgtcatgtcc

SEQ ID NO: 3 - DNA, 20 bp, synthetic construct
  source 1..20: mol_type = other DNA
cactcttccagccttccttc

SEQ ID NO: 4 - DNA, 20 bp, synthetic construct
  source 1..20: mol_type = other DNA
ccgtgtcgtttcttgaagcc

SEQ ID NO: 5 - DNA, 20 bp, synthetic construct
  source 1..20: mol_type = other DNA
gctcagaaccgaactcccag

SEQ ID NO: 6 - DNA, 20 bp, synthetic construct
  source 1..20: mol_type = other DNA
tgtaggcgtttctggacatg